(19) United States
(12) Patent Application Publication
(10) Pub. No.: US 2026/0155073 A1
(43) Pub. Date: Jun. 4, 2026

(54) DATA DRIVER, DISPLAY DEVICE INCLUDING THE DATA DRIVER AND ELECTRONIC DEVICE INCLUDING THE DISPLAY DEVICE

(71) Applicants: Samsung Display Co., LTD., Yongin-si (KR); IUCF-HYU (Industry-University Cooperation Foundation Hanyang University), Seoul (KR)

(72) Inventors: Mungyu KIM, Yongin-si (KR); Jaemyung LIM, Seoul (KR); Junsoo KO, Yongin-si (KR); Chankeun KWON, Yongin-si (KR); Hyungseup KIM, Yongin-si (KR); GICHANG LEE, Yongin-si (KR); Junhyuk JANG, Seoul (KR); Seoyeong JEONG, Seoul (KR)

(21) Appl. No.: 19/404,391

(22) Filed: Dec. 1, 2025

(30) Foreign Application Priority Data
Dec. 2, 2024 (KR) 10-2024-0176242

(51) Int. Cl. G09G 3/20

(52) U.S. Cl. CPC G09G 3/20; G09G 2310/027; G09G 2310/0286; G09G 2310/08; G09G 2330/021

(57) ABSTRACT

A data driver includes a shift register block which generates enable signals based on a data clock signal, a gating signal generating block which generates gating signals, a data transmission block including data gating circuits which receives a data signal and transmits the data signal to a latch block, and the latch block which stores the data signal based on the enable signals. Each of the data gating circuits includes data transmission paths and determines a target transmission path, which transmits the data signal to the latch block, among the data transmission paths based on the gating signals.

This application claims priority to Korean Patent Application No. 10-2024-0176242, filed on Dec. 2, 2024, and all the benefits accruing therefrom under 35 U.S.C. § 119, the content of which in its entirety is herein incorporated by reference.

### BACKGROUND

### 1. Field

Embodiments of the present disclosure relate to a data driver, a display device including the data driver, and an electronic device including the display device.

### 2. Description of the Related Art

A display device may include a display panel and a display panel driver. The display panel may include gate lines, emission lines, data lines, and pixels. The display panel driver may include a gate driver which provides a gate signal to the gate lines, an emission driver which provides an emission signal to the emission lines, a data driver which provides a data voltage to the data lines, and a driving controller which controls the gate driver, the emission driver, and the data driver.

The data driver may receive a data signal from the driving controller. The data driver may store the data signal in latch blocks therein. Recently, the data driver having a signal tree structure, which transmits the data signal to the latch blocks through a transmission circuit including data transmission paths, has been proposed to prevent delays that may occur when the data driver sequentially transmits data signals and the data signals are stored in the latch blocks.

### SUMMARY

In a display device including a conventional data driver having a signal tree structure, when the display device operates at a higher frame rate and has a higher resolution, power consumption for driving the data transmission paths included in the transmission circuit may be increased in the conventional data driver including the signal tree structure. In addition, additional lines for transmitting gating signals applied to the transmission circuit to drive the data transmission paths may be increased and a dead space of the display device may be increased.

An embodiment of the present disclosure provides a data driver which decreases power consumption of a display device and a dead space of the display device.

Another embodiment of the present disclosure provides the display device including the data driver.

Still another embodiment of the present disclosure provides an electronic device including the display device.

However, embodiments of the present disclosure are not limited thereto, and may be variously extended without departing from the spirit and scope of the present disclosure.

According to embodiments, a data driver includes a shift register block which generates enable signals based on a data clock signal, a gating signal generating block which generates gating signals, a data transmission block including data gating circuits which receives a data signal and transmits the data signal to a latch block, and the latch block which stores the data signal based on the enable signals. In such embodiments, each of the data gating circuits includes data transmission paths and determines a target transmission path, which transmits the data signal to the latch block, among the data transmission paths based on the gating signals.

In an embodiment, the gating signal generating block may generate the gating signals based on the enable signals.

In an embodiment, each of the data gating circuits may include an input block which receives the data signal, path circuits which transmits the data signal to output blocks based on the gating signals, and the output blocks which outputs the data signal to the latch block, and each of the data transmission paths may include the input block, at least one of the path circuits, and at least one of the output blocks.

In an embodiment, the input block may include at least one logic gate, each of the path circuits may include at least one logic gate, and each of the output blocks may include at least one logic gate.

In an embodiment, the input block may include at least one logic gate, each of the path circuits may include at least one logic gate and at least one switching element, and each of the output blocks may include at least one logic gate.

In an embodiment, target path circuits, which are included in the target transmission path, among the path circuits may be activated based on the gating signals, and remaining path circuits among the path circuits except for the target path circuits may be deactivated based on the gating signals.

In an embodiment, the gating signal generating block further may generate gating inversion signals, which have opposite phases to the gating signals, based on the enable signals and may output the gating inversion signals to the data transmission block.

In an embodiment, target path circuits, which are included in the target transmission path, among the path circuits may be activated based on the gating signals and the gating inversion signals, and remaining path circuits among the path circuits except for the target path circuits may be deactivated based on the gating signals and the gating inversion signals.

In an embodiment, the latch block may include latch circuits, each of the output blocks may include output circuits, and each of the output circuits may be connected to at least one of the latch circuits.

In an embodiment, the gating signal generating block may generate first to tenth gating signals, each of the data gating circuits may include an input block, first to tenth path circuits, and first to eighth output blocks, the input block may include an input terminal which receives the data signal and an output terminal connected to a first node, the first path circuit may include a first input terminal which receives the first gating signal, a second input terminal connected to the first node, and an output terminal connected to a third node, the second path circuit may include a first input terminal which receives the second gating signal, a second input terminal connected to the first node, and an output terminal connected to a fifth node, the third path circuit may include a first input terminal which receives the third gating signal, a second input terminal connected to the third node, and an output terminal connected to the first output block, the fourth path circuit may include a first input terminal which receives the fourth gating signal, a second input terminal connected to the third node, and an output terminal connected to the second output block, the fifth path circuit may include a first input terminal which receives the fifth gating signal, a second input terminal connected to the third node, and an output terminal connected to the third output block, the sixth path circuit may include a first input terminal which receives the sixth gating signal, a second input terminal connected to the third node, and an output terminal connected to the fourth output block, the seventh path circuit may include a first input terminal which receives the seventh gating signal, a second input terminal connected to the fifth node, and an output terminal connected to the fifth output block, the eighth path circuit may include a first input terminal which receives the eighth gating signal, a second input terminal connected to the fifth node, and an output terminal connected to the sixth output block, the ninth path circuit may include a first input terminal which receives the ninth gating signal, a second input terminal connected to the fifth node, and an output terminal connected to the seventh output block, and the tenth path circuit may include a first input terminal which receives the tenth gating signal, a second input terminal connected to the fifth node, and an output terminal connected to the eighth output block.

According to embodiments, a display device includes a display panel including pixels, a gate driver which transmits a gate signal to the pixels, a data driver which generates a data voltage based on a data signal and transmits the data voltage to the pixels, and a driving controller which transmit the data signal to the data driver and controls the data driver and the gate driver. In such embodiments, the data driver includes a shift register block which generates enable signals based on a data clock signal, a gating signal generating block which generates gating signals, a data transmission block including data gating circuits which receives the data signal and transmits the data signal to a latch block, and the latch block which stores the data signal based on the enable signals, and each of the data gating circuits may include data transmission paths and determines a target transmission path, which transmits the data signal to the latch block, among the data transmission paths based on the gating signals.

In an embodiment, the gating signal generating block may generate the gating signals based on the enable signals.

In an embodiment, each of the data gating circuits may include an input block which receives the data signal, path circuits which transmits the data signal to output blocks based on the gating signals, and the output blocks which outputs the data signal to the latch block, and each of the data transmission paths may include the input block, at least one of the path circuits, and at least one of the output blocks.

In an embodiment, the input block may include at least one logic gate, each of the path circuits may include at least one logic gate, and each of the output blocks may include at least one logic gate.

In an embodiment, the input block may include at least one logic gate, each of the path circuits may include at least one logic gate and at least one switching element, and each of the output blocks may include at least one logic gate.

In an embodiment, target path circuits, which are included in the target transmission path, among the path circuits may be activated based on the gating signals, and remaining path circuits among the path circuits except for the target path circuits may be deactivated based on the gating signals.

In an embodiment, the gating signal generating block further may generate gating inversion signals, which have opposite phases to the gating signals, based on the enable signals and may output the gating inversion signals to the data transmission block.

In an embodiment, target path circuits, which are included in the target transmission path, among the path circuits may be activated based on the gating signals and the gating inversion signals, and remaining path circuits among the path circuits except for the target path circuits may be deactivated based on the gating signals and the gating inversion signals.

In an embodiment, the latch block may include latch circuits, each of the output blocks may include output circuits, and each of the output circuits may be connected to at least one of the latch circuits.

According to embodiments, an electronic device includes a processor which generates an input control signal and input image data, a display panel including pixels, a gate driver which transmits a gate signal to the pixels, a data driver which generates a data voltage based on a data signal and transmits the data voltage to the pixels, and a driving controller which transmits the data signal to the data driver and controls the data driver and the gate driver based on the input control signal and the input image data. In such embodiments, the data driver includes a shift register block which generates enable signals based on a data clock signal, a gating signal generating block which generates gating signals, a data transmission block including data gating circuits which receives the data signal and transmits the data signal to a latch block, and the latch block which stores the data signal based on the enable signals, and each of the data gating circuits includes data transmission paths and determines a target transmission path, which transmits the data signal to the latch block, among the data transmission paths based on the gating signals.

Therefore, embodiments of the data driver and the display device including the data driver may include the gating signal generating block, the data transmission block, the shift register, and the latch block. The gating signal generating block may generate the gating signal group by using the enable signals output from the shift register block. Accordingly, the data driver may not use additional signals transmitted to the gating signal generating block for generating the gating signal group. That is, the data driver may not include an additional driver and lines for generating the additional signals. Accordingly, a dead space of the display device may be decreased. In addition, there may be no power consumption to drive the additional driver which generates the additional signals. That is, power consumption of the display device may be reduced.

In such embodiments, the data transmission block may include data transmission paths through which data signal may be transmitted. The data transmission block may determine the target transmission path through which the data signal is transmitted among the data transmission paths based on the gating signal group which is received from the gating signal generating block. The data transmission block may transmit the data signal to the latch block through the target transmission path. As the data signal is not transmitted to the latch block in the time-series manner and the data signal is transmitted to the latch block through the target transmission path, delays which may be caused by the time-series transmission process may be effectively prevented. Accordingly, reliability and stability of the data driver may be improved. That is, reliability and stability of the display device may be improved.

In such embodiments, as the remaining path circuits included in the data transmission paths except for the target transmission path are deactivated, the data signal may not be transmitted through the data transmission paths except for the target transmission path. Accordingly, power consumption caused by transmitting the data signal to the latch block may be reduced. That is, the power consumption of the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a diagram illustrating a display panel included in the display device of FIG. 1 which is divided into display regions.

FIG. 3 is a block diagram illustrating a data driver included in the display device of FIG. 1.

FIG. 4 is a block diagram illustrating an operation of a data transmission block included in the data driver of FIG. 3.

FIG. 5 is a signal timing diagram illustrating an embodiment of a gating signal group generated by a gating signal generating block included in the data driver of FIG. 3.

FIG. 6 is a circuit diagram illustrating an embodiment of a data gating circuit included in the data transmission block of FIG. 4.

FIG. 7 is a circuit diagram illustrating an embodiment of an operation of the data gating circuit of FIG. 6.

FIG. 8 is a diagram illustrating an embodiment of an output block included in the data gating circuit of FIG. 6.

FIG. 9 is a circuit diagram illustrating an embodiment of an operation of the data gating circuit of FIG. 6.

FIG. 10 is a circuit diagram illustrating an embodiment of an operation of the data gating circuit of FIG. 6.

FIG. 11 is a circuit diagram illustrating an embodiment of an operation of the data gating circuit of FIG. 6.

FIG. 12 is a circuit diagram illustrating an embodiment of an operation of the data gating circuit of FIG. 6.

FIG. 13 is a circuit diagram illustrating an embodiment of an operation of the data gating circuit of FIG. 6.

FIG. 14 is a circuit diagram illustrating an embodiment of an operation of the data gating circuit of FIG. 6.

FIG. 15 is a circuit diagram illustrating an embodiment of an operation of the data gating circuit of FIG. 6.

FIG. 16 is a diagram illustrating a process of transmitting a data signal through the data transmission block of FIG. 4.

FIG. 17 is a diagram illustrating an embodiment of an output block included in the data gating circuit of FIG. 6.

FIG. 18 is a diagram illustrating a transmission gate.

FIG. 19 is a circuit diagram illustrating an embodiment of a data gating circuit included in the data transmission block of FIG. 4.

FIG. 20 is a block diagram illustrating an electronic device according to embodiments.

FIG. 21 is a diagram illustrating an example in which the electronic device of FIG. 20 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, display devices in accordance with embodiments will be described in more detail with reference to the accompanying drawings. The same reference numerals are used for the same components in the drawings, and any repetitive detailed descriptions of the same components will be omitted or simplified.

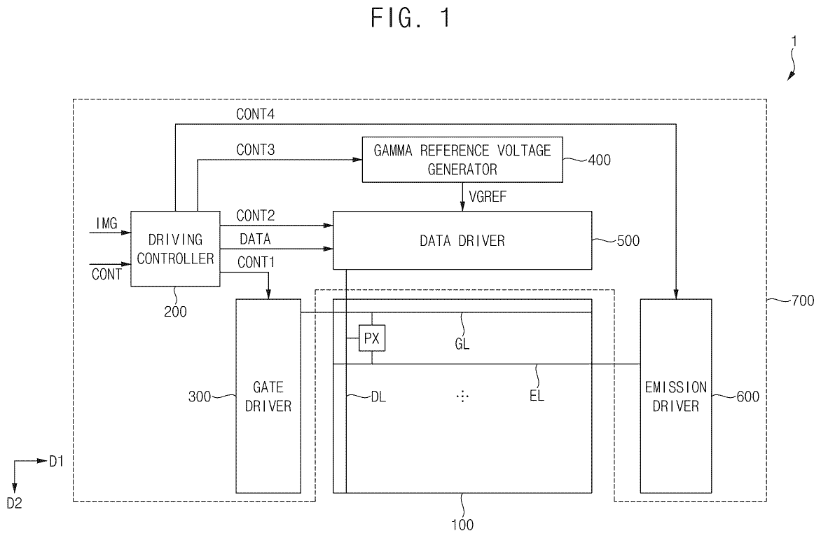

FIG. 1 is a block diagram illustrating a display device 1 according to embodiments.

Referring to FIG. 1, an embodiment of the display device 1 may include a display panel 100 and a display panel driver 700. The display panel driver 700 may include a driving controller 200, a gate driver 300, a gamma reference voltage generator 400, a data driver 500, and an emission driver 600.

In an embodiment, for example, the driving controller 200 and the data driver 500 may be integrated into a single chip. In an embodiment, for example, the driving controller 200, the gate driver 300, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region, on which an image is displayed, and a peripheral region adjacent to the display region. In an embodiment, for example, the peripheral region may be referred to as a bezel.

The display panel 100 may include gate lines GL, emission lines EL, data lines DL, and pixels PX. In an embodiment, for example, the gate lines GL may extend in a first direction D1, the emission lines EL may extend in the first direction D1, and the data lines DL may extend in a second direction D2 crossing the first direction D1.

The driving controller 200 may receive input image data IMG and an input control signal CONT from an external device. In an embodiment, for example, the input image data IMG may include red image data, green image data, and blue image data. In some embodiments, the input image data IMG may further include white image data. In another embodiment, for example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, an emission control signal CONT4, and a data signal DATA based on the input image data IMG and the input control signal CONT. In an embodiment, for example, the data signal DATA may be one of a red data signal, a green data signal, and a blue data signal.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the emission control signal CONT4 for controlling an operation of the emission driver 600 based on the input control signal CONT, and may output the emission control signal CONT4 to the emission driver 600.

The gate driver 300 may generate gate signals transmitted to the pixels PX through the gate lines GL in response to the gate control signal CONT1 received from the driving controller 200. The gate driver 300 may output the gate signals to the gate lines GL. In an embodiment, for example, the gate driver 300 may sequentially output the gate signals to the gate lines GL. In an embodiment, for example, the gate driver 300 may be integrated on the peripheral region of the display panel 100.

The gamma reference voltage generator 400 may generate a gamma reference voltage VGREF in response to the gamma control signal CONT3 received from the driving controller 200. The gamma reference voltage generator 400 may provide the gamma reference voltage VGREF to the data driver 500.

In an embodiment, for example, the gamma reference voltage generator 400 may be disposed in the driving controller 200 or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

The data driver 500 may include a gating signal generating block that generates gating signals and a data transmission block that determines a target transmission path, through which the data signal DATA is transmitted, among data transmission paths based on the gating signals. The data driver 500 will be described in detail below.

The emission driver 600 may generate emission signals transmitted to the pixels PX through the emission lines EL in response to the emission control signal CONT4 received from the driving controller 200. The emission driver 600 may output the emission signals to the emission lines EL. In an embodiment, for example, the emission driver 600 may sequentially output the emission signals to the emission lines EL. In an embodiment, for example, the emission driver 600 may be integrated on the peripheral region of the display panel 100.

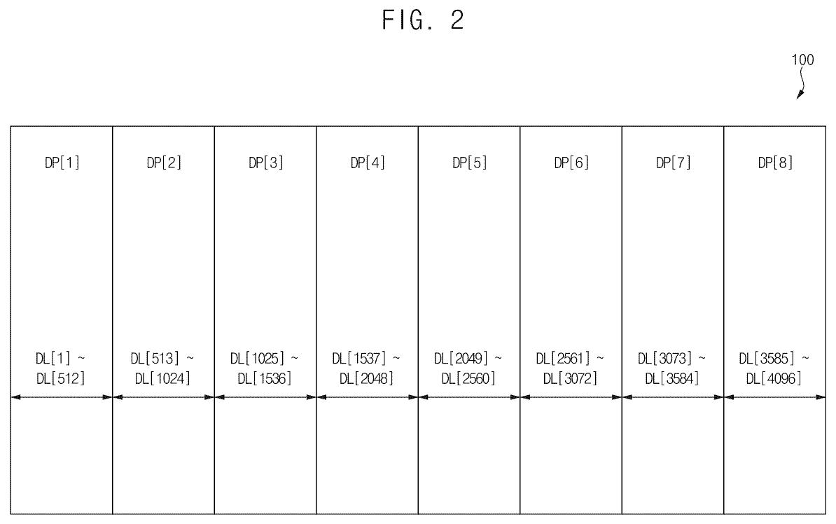

FIG. 2 is a diagram illustrating the display panel 100 included in the display device 1 of FIG. 1 which is divided into display regions.

Referring to FIG. 2, an embodiment of the display panel 100 may be divided into the display regions. In such an embodiment, the display panel 100 may include the data lines DL. For convenience of illustration and description, FIG. 2 shows an embodiment where the display panel 100 is divided into first to eighth display regions DP[1] to DP[8] and includes first to 4096-th data lines DL[1] to DL[4096] as an example, but not being limited thereto.

The first display region DP[1] may include the first to 512-th data lines DL[1] to DL[512]. The second display region DP[2] may include the 513-th to 1024-th data lines DL[513] to DL[1024]. The third display region DP[3] may include the 1025-th to 1536-th data lines DL[1025] to DL[1536]. The fourth display region DP[4] may include the 1537-th to 2048-th data lines DL[1537] to DL[2048]. The fifth display region DP[5] may include the 2049-th to 2560-th data lines DL[2049] to DL[2560]. The sixth display region DP[6] may include the 2561-th to 3072-th data lines DL[2561] to DL[3072]. The seventh display region DP[7] may include the 3073-th to 3584-th data lines DL[3073] to DL[3584]. The eighth display region DP[8] may include the 3585-th to 4096-th data lines DL[3585] to DL[4096].

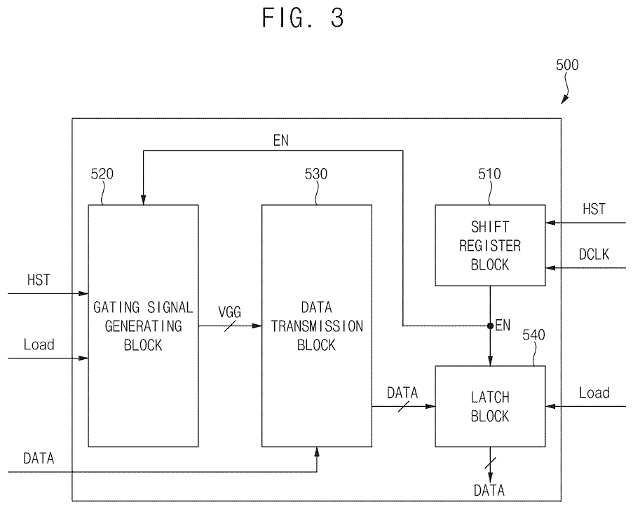

FIG. 3 is a block diagram illustrating the data driver 500 included in the display device 1 of FIG. 1.

Referring to FIG. 3, an embodiment of the data driver 500 may include a shift register block 510, a gating signal generating block 520, a data transmission block 530, and a latch block 540.

The shift register block 510 may start generating enable signals EN in response to the horizontal start signal HST. In addition, the shift register block 510 may sequentially generate the enable signals EN based on a data clock signal DCLK.

In an embodiment, the shift register block 510 may include flip-flops connected to each other in series to sequentially generate the enable signals EN.

The shift register block 510 may output the enable signals EN to the gating signal generating block 520 and the latch block 540.

The gating signal generating block 520 may be reset by the load signal Load received from the driving controller 200. The gating signal generating block 520 may start generating a gating signal group VGG in response to the horizontal start signal HST. The gating signal generating block 520 may generate the gating signal group VGG, which determines a target transmission path of the data signal DATA, based on the enable signals EN. The gating signal group VGG may be transmitted to the data transmission block 530.

In an embodiment, the gating signal generating block 520 may include the flip-flops (e.g. D flip-flops) and XOR gates, but the gating signal generating block 520 is not limited thereto.

The latch block 540 may store the data signal DATA received from the data transmission block 530 based on the enable signals EN and the load signal Load and may output the data signal DATA, which is stored in the latch block 540, based on the enable signals EN and the load signal Load.

In an embodiment, the gating signal generating block 520 may generate the gating signal group VGG by using the enable signals EN output from the shift register block 510. Accordingly, the data driver 500 may not use additional signals transmitted to the gating signal generating block 520 for generating the gating signal group VGG. That is, the data driver 500 may not include an additional driver and lines for generating the additional signals. Accordingly, a dead space of the display device 1 may be decreased. In such an embodiment, there may be no power consumption to drive the additional driver which generates the additional signals. That is, power consumption of the display device 1 may be reduced.

In an embodiment, the data transmission block 530 may determine the target transmission path, through which the data signal DATA is transmitted, among the data transmission paths based on the gating signal group VGG, which is received from the gating signal generating block 520. The data transmission block 530 may transmit the data signal DATA to the latch block 540 through the target transmission path. As the data signal DATA is not transmitted to the latch block 540 in a time-series manner and the data signal DATA is transmitted to the latch block 540 through the target transmission path, delays which may be caused by a time-series transmission process may be effectively prevented. Accordingly, reliability and stability of the data driver 500 may be improved.

In such an embodiment, as remining path circuits included in the data transmission paths except for the target transmission path are deactivated, the data signal DATA may not be transmitted through the data transmission paths except for the target transmission path. Accordingly, power consumption caused by transmitting the data signal DATA to the latch block 540 may be reduced. That is, the power consumption of the display device 1 may be reduced.

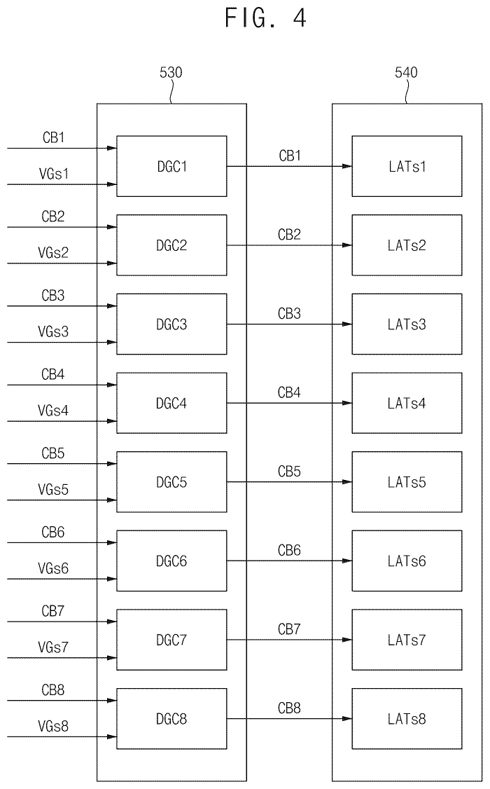

FIG. 4 is a block diagram illustrating an operation of the data transmission block 530 included in the data driver 500 of FIG. 3.

Referring to FIG. 4, in an embodiment, the data transmission block 530 may receive the data signal DATA and may transmit the data signal DATA to the latch block 540 based on the gating signal group VGG. The data signal DATA may be one of the red data signal, the green data signal, and the blue data signal. In addition, the data signal DATA may include component bits. For convenience of illustration and description, FIG. 4 shows an embodiment where the data signal DATA includes first to eighth component bits CB1 to CB8 as an example, but not being limited thereto. Each of the first to eighth component bits CB1 to CB8 may be 1 bit.

In such an embodiment, the latch block 540 may include first to eighth latch blocks LATs1 to LATs8 which store the first to eighth component bits CB1 to CB8.

In such an embodiment, the gating signal group VGG may include first to eighth gating signal sub groups VGs1 to VGs8 for determining the target transmission paths through which the first to eighth component bits CB1 to CB8 is transmitted to the first to eighth latch blocks LATs1 to LATs8.

The data transmission block 530 may include first to eighth data gating circuits DGC1 to DGC8.

The first data gating circuit DGC1 may transmit the first component bit CB1 to the first latch block LATs1 through the target transmission path based on the first gating signal sub group VGs1.

The second data gating circuit DGC2 may transmit the second component bit CB2 to the second latch block LATs2 through the target transmission path based on the second gating signal sub group VGs2.

The third data gating circuit DGC3 may transmit the third component bit CB3 to the third latch block LATs3 through the target transmission path based on the third gating signal sub group VGs3.

The fourth data gating circuit DGC4 may transmit the fourth component bit CB4 to the fourth latch block LATs4 through the target transmission path based on the fourth gating signal sub group VGs4.

The fifth data gating circuit DGC5 may transmit the fifth component bit CB5 to the fifth latch block LATs5 through the target transmission path based on the fifth gating signal sub group VGs5.

The sixth data gating circuit DGC6 may transmit the sixth component bit CB6 to the sixth latch block LATs6 through the target transmission path based on the sixth gating signal sub group VGs6.

The seventh data gating circuit DGC7 may transmit the seventh component bit CB7 to the seventh latch block LATs7 through the target transmission path based on the seventh gating signal sub group VGs7.

The eighth data gating circuit DGC8 may transmit the eighth component bit CB8 to the eighth latch block LATs8 through the target transmission path based on the eighth gating signal sub group VGs8.

In such an embodiment, as described above, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

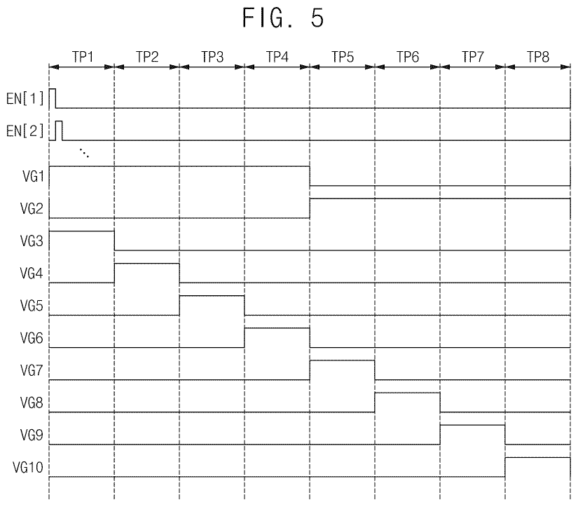

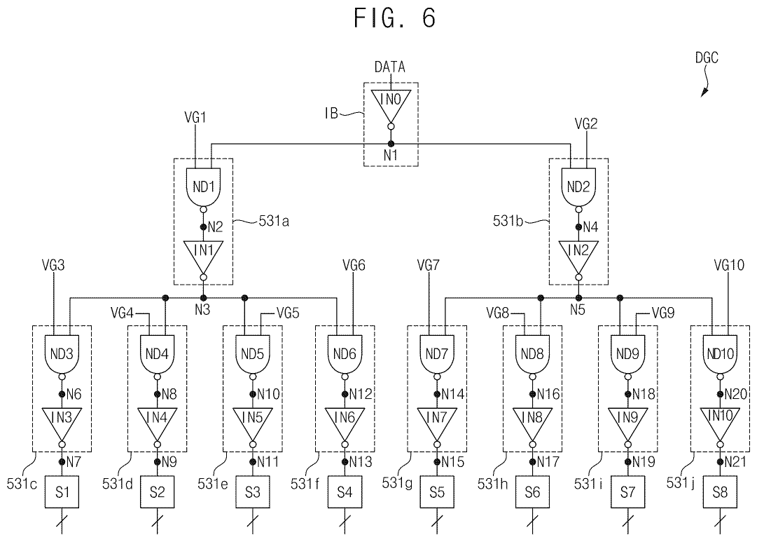

FIG. 5 is a signal timing diagram illustrating an embodiment of the gating signal group VGG generated by the gating signal generating block 520 included in the data driver 500 of FIG. 3. FIG. 6 is a circuit diagram illustrating an embodiment of the data gating circuit DGC included in the data transmission block 530 of FIG. 4.

One of the data gating circuits DGC may receive one of the first to eighth component bits CB1 to CB8. In addition, the gating signal sub group VGs may include the gating signals. For convenience of illustration and description, FIG. 5 shows an embodiment where the gating signal sub group VGs includes first to tenth gating signals VG1 to VG10 as an example, but not being limited thereto.

Referring to FIG. 5, in an embodiment, the gating signal generating block 520 may generate the gating signal sub group VGs based on the enable signals EN. The gating signal sub group VGs may include the first to tenth gating signals VG1 to VG10.

The first gating signals VG1 may have an activation level (e.g. a high level) during first to fourth periods TP1 to TP4 and may have a deactivation level (e.g. a low level) during fifth to eighth periods TP5 to TP8.

The second gating signals VG2 may have the deactivation level during the first to fourth periods TP1 to TP4 and may have the activation level during the fifth to eighth periods TP5 to TP8.

The third gating signals VG3 may have the activation level during the first period TP1 and may have the deactivation level during the second to eighth periods TP2 to TP8.

The fourth gating signals VG4 may have the activation level during the second period TP2 and may have the deactivation level during the first period TP1 and the third to eighth periods TP3 to TP8.

The fifth gating signals VG5 may have the activation level during the third period TP3 and may have the deactivation level during the first period TP1, the second period TP2, and the fourth to eighth periods TP4 to TP8.

The sixth gating signals VG6 may have the activation level during the fourth period TP4 and may have the deactivation level during the first to third periods TP1 to TP3 and the fifth to eighth periods TP5 to TP8.

The seventh gating signals VG7 may have the activation level during the fifth period TP5 and may have the deactivation level during the first to fourth periods TP1 to TP4 and the sixth to eighth periods TP6 to TP8.

The eighth gating signals VG8 may have the activation level during the sixth period TP6 and may have the deactivation level during the first to fifth periods TP1 to TP5, the seventh period TP7, and the eighth period TP8.

The ninth gating signals VG9 may have the activation level during the seventh period TP7 and may have the deactivation level during the first to sixth periods TP1 to TP6 and the eighth period TP8.

The tenth gating signals VG10 may have the activation level during the eighth period TP8 and may have the deactivation level during the first to seventh periods TP1 to TP7.

Referring to FIG. 6, in an embodiment, the data gating circuit DGC may include the input block IB, first to tenth path circuits 531a to 531j, and the first to eighth output blocks S1 to S10.

The input block IB may include an input inverter IN0. The input inverter IN0 may include an input terminal which receives the data signal DATA and an output terminal connected to a first node N1.

The first path circuit 531a may include a first NAND gate ND1 and a first inverter IN1.

The first NAND gate ND1 may include a first input terminal which receives the first gating signal VG1, a second input terminal connected to the first node N1, and an output terminal connected to a second node N2.

The first inverter IN1 may include an input terminal connected to the second node N2 and an output terminal connected to a third node N3.

The second path circuit 531b may include a second NAND gate ND2 and a second inverter IN2.

The second NAND gate ND2 may include a first input terminal which receives the second gating signal VG2, a second input terminal connected to the first node N1, and an output terminal connected to a fourth node N4.

The second inverter IN2 may include an input terminal connected to the fourth node N4 and an output terminal connected to a fifth node N5.

The third path circuit 531c may include a third NAND gate ND3 and a third inverter IN3.

The third NAND gate ND3 may include a first input terminal which receives the third gating signal VG3, a second input terminal connected to the third node N3, and an output terminal connected to a sixth node N6.

The third inverter IN3 may include an input terminal connected to the sixth node N6 and an output terminal connected to a seventh node N7.

The fourth path circuit 531d may include a fourth NAND gate ND4 and a fourth inverter IN4.

The fourth NAND gate ND4 may include a first input terminal which receives the fourth gating signal VG4, a second input terminal connected to the third node N3, and an output terminal connected to an eighth node N8.

The fourth inverter IN4 may include an input terminal connected to the eighth node N8 and an output terminal connected to a ninth node N9.

The fifth path circuit 531e may include a fifth NAND gate ND5 and a fifth inverter IN5.

The fifth NAND gate ND5 may include a first input terminal which receives the fifth gating signal VG5, a second input terminal connected to the third node N3, and an output terminal connected to a tenth node N10.

The fifth inverter IN5 may include an input terminal connected to the tenth node N10 and an output terminal connected to an eleventh node N11.

The sixth path circuit 531f may include a sixth NAND gate ND6 and a sixth inverter IN6.

The sixth NAND gate ND6 may include a first input terminal which receives the sixth gating signal VG6, a second input terminal connected to the third node N3, and an output terminal connected to a twelfth node N12.

The sixth inverter IN6 may include an input terminal connected to the twelfth node N12 and an output terminal connected to a thirteenth node N13.

The seventh path circuit 531g may include a seventh NAND gate ND7 and a seventh inverter IN7.

The seventh NAND gate ND7 may include a first input terminal which receives the seventh gating signal VG7, a second input terminal connected to the fifth node N5, and an output terminal connected to a fourteenth node N14.

The seventh inverter IN7 may include an input terminal connected to the fourteenth node N14 and an output terminal connected to a fifteenth node N15.

The eighth path circuit 531h may include an eighth NAND gate ND8 and an eighth inverter IN8.

The eighth NAND gate ND8 may include a first input terminal which receives the eighth gating signal VG8, a second input terminal connected to the fifth node N5, and an output terminal connected to a sixteenth node N16.

The eighth inverter IN8 may include an input terminal connected to the sixteenth node N16 and an output terminal connected to a seventeenth node N17.

The ninth path circuit 531i may include a ninth NAND gate ND9 and a ninth inverter IN9.

The ninth NAND gate ND9 may include a first input terminal which receives the ninth gating signal VG9, a second input terminal connected to the fifth node N5, and an output terminal connected to an eighteenth node N18.

The ninth inverter IN9 may include an input terminal connected to the eighteenth node N18 and an output terminal connected to a nineteenth node N19.

The tenth path circuit 531j may include a tenth NAND gate ND10 and a tenth inverter IN10.

The tenth NAND gate ND10 may include a first input terminal which receives the tenth gating signal VG10, a second input terminal connected to the fifth node N5, and an output terminal connected to a twentieth node N20.

The tenth inverter IN10 may include an input terminal connected to the twentieth node N20 and an output terminal connected to a 21-th node N21.

The data gating circuit DGC may include the first to eighth output blocks S1 to S8.

In an embodiment, as described above, each of the first to tenth path circuits 531a to 531j may include one NAND gate and one inverter, but the first to tenth path circuits 531a to 531j is not limited thereto. In another embodiment, for example, each of the first to tenth path circuits 531a to 531j may include one AND gate. In another embodiment, for example, each of the first to tenth path circuits 531a to 531j may include one NAND gate and one inverter and further include resistor and capacitor.

An input terminal of the first output block S1 may be connected to the seventh node N7. An input terminal of the second output block S2 may be connected to the ninth node N9. An input terminal of the third output block S3 may be connected to the eleventh node N7. An input terminal of the fourth output block S4 may be connected to the thirteenth node N13. An input terminal of the fifth output block S5 may be connected to the fifteenth node N15. An input terminal of the sixth output block S6 may be connected to the seventeenth node N17. An input terminal of the seventh output block S7 may be connected to the nineteenth node N19. An input terminal of the eighth output block S8 may be connected to the 21-th node N21.

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path.

Accordingly, the power consumption caused by transmitting the data signal DATA to the latch block 540 may be reduced. That is, the power consumption of the display device 1 may be reduced.

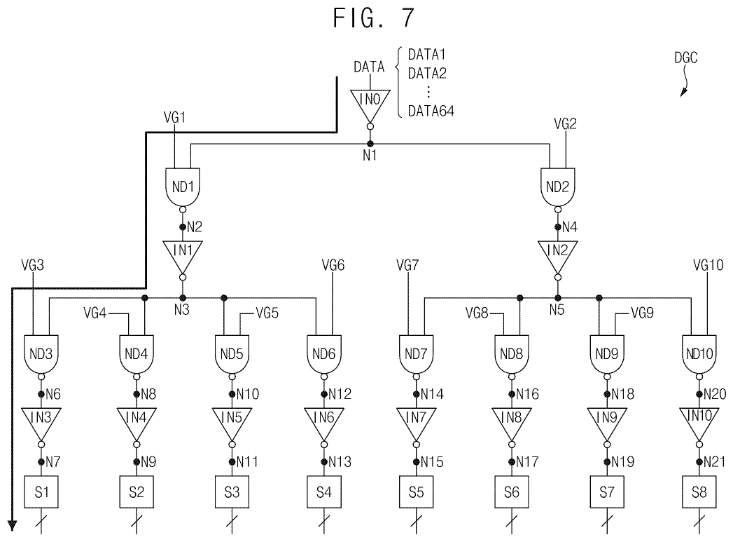

FIG. 7 is a circuit diagram illustrating an embodiment of an operation of the data gating circuit DGC of FIG. 6.

Referring to FIG. 7, in an embodiment, the data signal DATA may be applied to the input terminal of the input inverter IN0. The data signal DATA may be one of first to 64-th data signals DATA1 to DATA64. In addition, the data gating circuit DGC may include first to eighth data transmission paths.

In the first period TP1 of FIG. 5, the first data transmission path may be the target transmission path which transmits the data signal DATA to the latch block 540.

The first data transmission path may include the input inverter IN0, the first path circuit 531a, and the third path circuit 531c. The first path circuit 531a and the third path circuit 531c may be target path circuits in the first data transmission path.

In first period TP1, the first gating signal VG1 and the third gating signal VG3 may have the activation levels and the second gating signal VG2 and the fourth to tenth gating signals VG4 to VG10 may have the deactivation levels.

As the first gating signal VG1 and the third gating signal VG3 have the activation level in the first period TP1, the first path circuit 531a and the third path circuits 531c may be activated. In addition, as the second gating signal VG2 and the fourth to tenth gating signals VG4 to VG10 may have the deactivation levels in the first period TP1, the second path circuit 531b and the fourth to tenth path circuits 531d to 531j may be deactivated.

The data signal DATA may be inverted by the input inverter IN0, the first path circuit 531a which is activated, and the third path circuit 531c which is activated and may be transmitted to the first output block S1. A high voltage may be transmitted to the second to eighth output blocks S2 to S8.

The data signal DATA may be applied to the input terminal of the input inverter IN0. The input inverter IN0 may output the data signal DATA, which is inverted, to the first node N1.

The first NAND gate ND1 may invert the data signal DATA, which is inverted, in response to the first gating signal VG1. That is, the first NAND gate ND1 may output the data signal DATA to the second node N2. The first inverter IN1 may invert the data signal DATA of the second node N2. Accordingly, the first inverter IN1 may output the data signal DATA, which is inverted, to the third node N3.

The third NAND gate ND3 may invert the data signal DATA, which is inverted, of the third node N3 in response to the third gating signal VG3. That is, the third NADN gate ND3 may output the data signal DATA to the sixth node N6. The third inverter IN3 may invert the data signal DATA of the sixth node N6. Accordingly, the third inverter IN3 may output the data signal DATA, which is inverted, to the seventh node N7. That is, the data signal DATA, which is inverted, may be transmitted to the first output block S1.

The second NAND gate ND2 may output a low voltage to the fourth node N4 in response to the second gating signal VG2. The second inverter IN2 may invert a voltage of the fourth node N4. Accordingly, the second inverter IN2 may output the high voltage to the fifth node N5.

The fourth NAND gate ND4 may output the low voltage to the eighth node N8 in response to the fourth gating signal VG4. The fourth inverter IN4 may invert a voltage of the eighth node N8. Accordingly, the fourth inverter IN4 may output the high voltage to the ninth node N9. That is, the high voltage may be transmitted to the second output block S2.

The fifth NAND gate ND5 may output the low voltage to the tenth node N10 in response to the fifth gating signal VG5. The fifth inverter IN5 may invert a voltage of the tenth node N10. Accordingly, the fifth inverter IN5 may output the high voltage to the eleventh node N11. That is, the high voltage may be transmitted to the third output block S3.

The sixth NAND gate ND6 may output the low voltage to the twelfth node N12 in response to the sixth gating signal VG6. The sixth inverter IN6 may invert a voltage of the twelfth node N12. Accordingly, the sixth inverter IN6 may output the high voltage to the thirteenth node N13. That is, the high voltage may be transmitted to the fourth output block S4.

The seventh NAND gate ND7 may output the low voltage to the fourteenth node N14 in response to the seventh gating signal VG7. The seventh inverter IN7 may invert a voltage of the fourteenth node N14. Accordingly, the seventh inverter IN7 may output the high voltage to the fifteenth node N15. That is, the high voltage may be transmitted to the fifth output block S5.

The eighth NAND gate ND8 may output the low voltage to the sixteenth node N16 in response to the eighth gating signal VG8. The eighth inverter IN8 may invert a voltage of the sixteenth node N16. Accordingly, the eighth inverter IN8 may output the high voltage to the seventeenth node N17. That is, the high voltage may be transmitted to the sixth output block S6.

The ninth NAND gate ND9 may output the low voltage to the eighteenth node N18 in response to the ninth gating signal VG9. The ninth inverter IN9 may invert a voltage of the eighteenth node N18. Accordingly, the ninth inverter IN9 may output the high voltage to the nineteenth node N19. That is, the high voltage may be transmitted to the seventh output block S7.

The tenth NAND gate ND10 may output the low voltage to the twentieth node N20 in response to the tenth gating signal VG10. The tenth inverter IN10 may invert a voltage of the twentieth node N20. Accordingly, the tenth inverter IN10 may output the high voltage to the 21-th node N21. That is, the high voltage may be transmitted to the eighth output block S8.

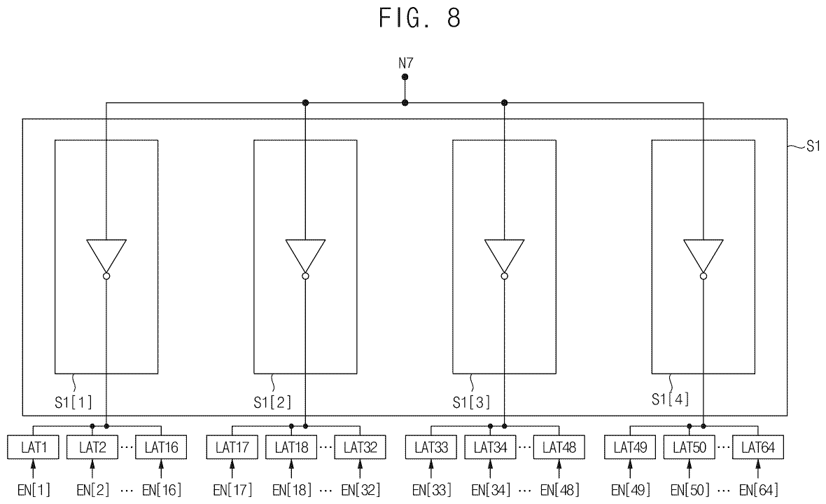

FIG. 8 is a diagram illustrating an embodiment of the output block included in the data gating circuit DGC of FIG. 6.

In an embodiment, the data gating circuit DGC may include the first to eighth output blocks S1 to S8. An component and an operation of the first to eighth output blocks S1 to S8 may be the same as each other. Accordingly, for convenience of description, a case where the target transmission path through which the data signal DATA is transmitted is the first data transmission path will be mainly described. In addition, it will be described with respect to the first output block S1.

Referring to FIG. 8, in an embodiment, the first output block S1 may include first to fourth output circuits S1[1] to S1[4].

Each of the first to fourth output circuits S1[1] to S1[4] may include one inverter. In addition, the latch block 540 may include first to 64-th latch circuits LAT1 to LAT64. In addition, The enable signals EN may include first to 64-th enable signals EN[1] to EN[64].

An input terminal of each of the first to fourth output circuits S1[1] to S1[4] may receive the data signal DATA, which is inverted, of the seventh node N7.

The input terminal of each of the first to fourth output circuits S1[1] to S1[4] may be connected to the seventh node N7.

An output terminal of the first output circuit S1[1] may be connected to the first to sixteenth latch circuits LAT1 to LAT16. An output terminal of the second output circuit S1[2] may be connected to the seventeenth to 32-th latch circuits LAT17 to LAT32. An output terminal of the third output circuit S1[3] may be connected to the 33-th to 48-th latch circuits LAT33 to LAT48. An output terminal of the fourth output circuit S1[4] may be connected to the 49-th to 64-th latch circuits LAT49 to LAT64.

Each of the first to fourth output circuits S1[1] to S1[4] may invert the data signal DATA which is inverted. That is, the each of the first to fourth output circuits S1[1] to S1[4] may output the data signal DATA. Accordingly, the data signal DATA may be transmitted to the first to 64-th latch circuits LAT1 to LAT64.

The data signal DATA, which is transmitted to the first to 64-th latch circuits LAT1 to LAT64, may be stored in one of the first to 64-th latch circuits LAT1 to LAT64 based on the enable signals EN. In an embodiment, for example, when the first enable signal EN[1] has an activation level (e.g. the high level), the first data signal DATA1 may be stored in the first latch circuit LAT1. In addition, when the second enable signal EN[2] has an activation level, the second data signal DATA2 may be stored in the second latch circuit LAT2. In this way, when the 64-th enable signal EN[64] has an activation level, the 64-th data signal DATA64 may be stored in the 64-th latch circuit LAT64

In such an embodiment, the high voltage of each of the ninth node N9, the eleventh node N11, the thirteenth node N13, the fifteenth node N15, the seventeenth node N17, the nineteenth node N19, and the 21-th node N21 may be inverted to the low voltage by the second to eighth output blocks S2 to S8. Accordingly, the data signal DATA may not be transmitted to the second to eighth output blocks S2 to S8.

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In addition, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

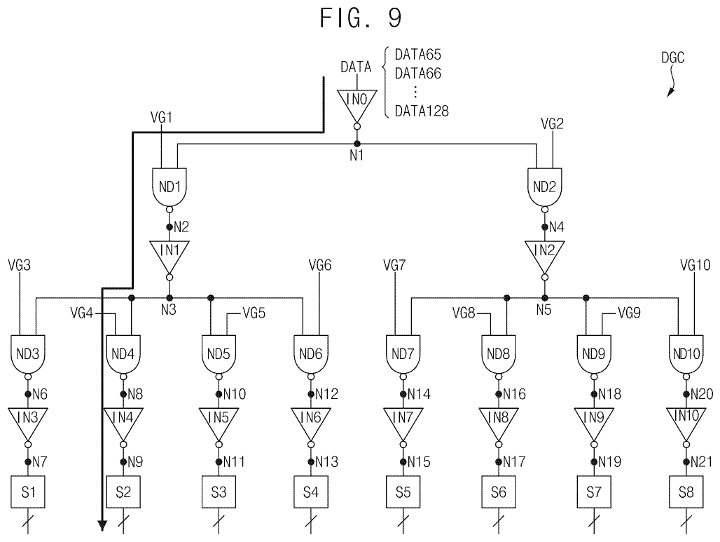

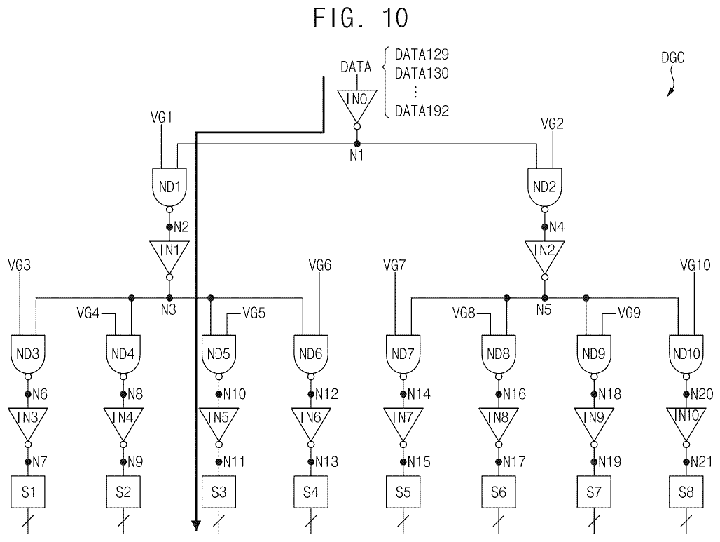

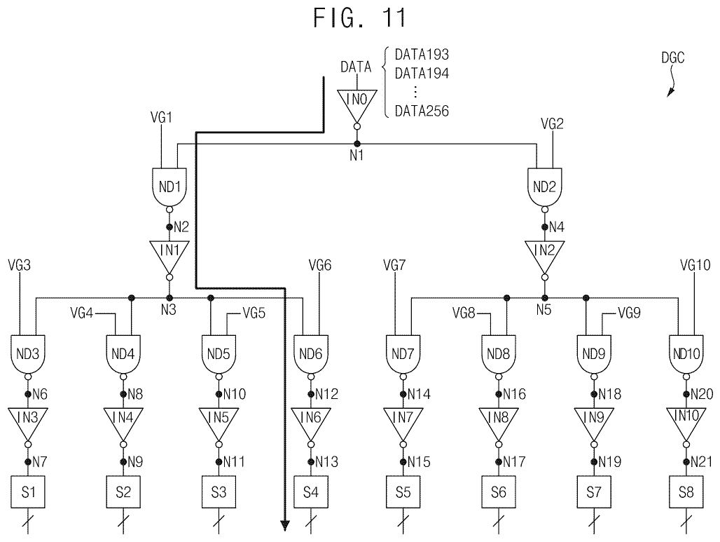

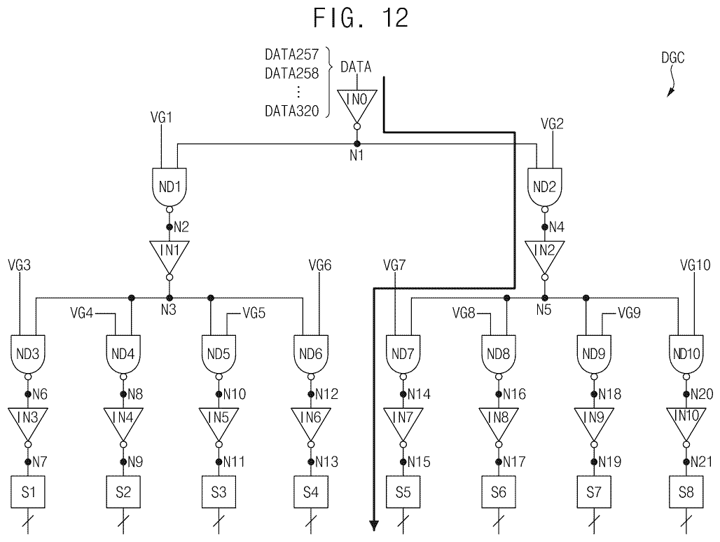

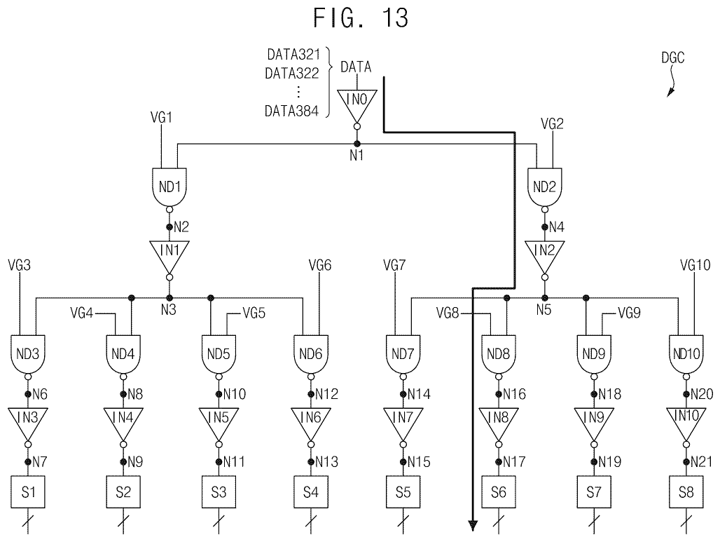

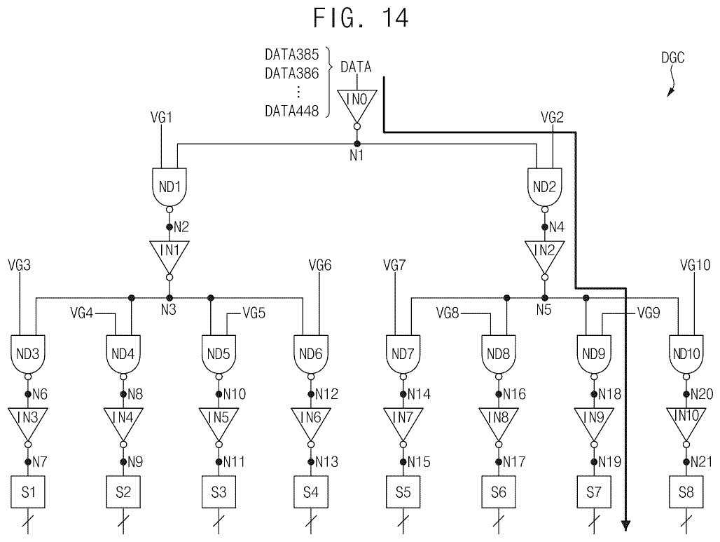

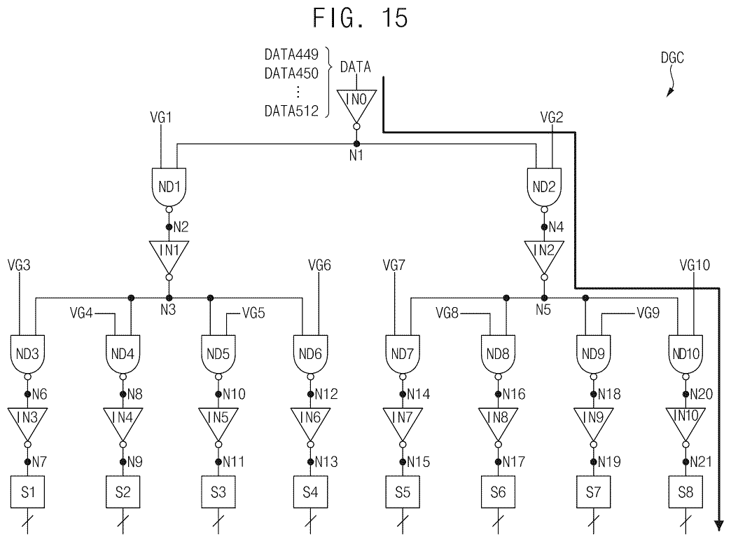

FIG. 9 is a circuit diagram illustrating an embodiment of an operation of the data gating circuit DGC of FIG. 6. FIG. 10 is a circuit diagram illustrating an embodiment of an operation of the data gating circuit DGC of FIG. 6. FIG. 11 is a circuit diagram illustrating an embodiment of an operation of the data gating circuit DGC of FIG. 6. FIG. 12 is a circuit diagram illustrating an embodiment of an operation of the data gating circuit DGC of FIG. 6. FIG. 13 is a circuit diagram illustrating an embodiment of an operation of the data gating circuit DGC of FIG. 6. FIG. 14 is a circuit diagram illustrating an embodiment of an operation of the data gating circuit DGC of FIG. 6. FIG. 15 is a circuit diagram illustrating an embodiment of an operation of the data gating circuit DGC of FIG. 6.

Referring to FIG. 9, the data signal DATA may be applied to the input terminal of the input inverter IN0. The data signal DATA may be one of 65-th to 128-th data signals DATA65 to DATA128.

In the second period TP2 of FIG. 5, the second data transmission path may be the target transmission path which transmits the data signal DATA to the latch block 540.

The second data transmission path may include the input inverter IN0, the first path circuit 531a, and the fourth path circuit 531d. The first path circuit 531a and the fourth path circuit 531d may be the target path circuits in the second period TP2.

In the second period TP2, the first gating signal VG1 and the fourth gating signal VG4 may have the activation levels and the second gating signal VG2, the third gating signal VG3, and the fifth to tenth gating signals VG5 to VG10 may have the deactivation levels.

As the first gating signal VG1 and the fourth gating signal VG4 have the activation levels in the second period TP2, the first path circuit 53 la and the fourth path circuit 531d may be activated. In addition, as the second gating signal VG2, the third gating signal VG3, and the fifth to tenth gating signals VG5 to VG10 have the deactivation levels in the second period TP2, the second path circuit 531b, the third path circuit 531c, and the fifth to tenth path circuits 531e to 531j may be deactivated.

According to the same method described above with reference to FIG. 7 and FIG. 8, the data signal DATA may be inverted by the input inverter IN0, the first path circuit 531a which is activated, and the fourth path circuit 531d which is activated. The data signal DATA, which is inverted, may be transmitted to the second output block S2. The high voltage may be transmitted to the first output block S1 and the third to eighth output blocks S3 to S8.

The data signal DATA, which is inverted, of the ninth node N9 may be inverted to the data signal DATA by the second output block S2. In addition, the high voltage of each of the seventh node N7, the eleventh node N11, the thirteenth node N13, the fifteenth node N15, the seventeenth node N17, the nineteenth node N19, and the 21-th node N21 may be inverted to the low voltage by the third to eighth output blocks S2 to S8.

The data signal DATA may be transmitted to the 65-th to 128-th latch circuits. In addition, the data signal DATA may be stored in one of the 65-th to 128-th latch circuits based on the enable signals EN. In an embodiment, for example, when the 65-th enable signal has the activation level, the 65-the data signal DATA65 may be stored in the 65-th latch circuit. In addition, when the 66-th enable signal has the activation level, the 66-the data signal DATA66 may be stored in the 66-th latch circuit. In this way, when the 128-th enable signal has the activation level, the 128-the data signal DATA 128 may be stored in the 128-th latch circuit.

Referring to FIG. 10, the data signal DATA may be applied to the input terminal of the input inverter IN0. The data signal DATA may be one of 129-th to 192-th data signals DATA129 to DATA192.

In the third period TP3 of FIG. 5, the third data transmission path may be the target transmission path which transmits the data signal DATA to the latch block 540.

The third data transmission path may include the input inverter IN0, the first path circuit 531a, and the fifth path circuit 531e. The first path circuit 351a and the fifth path circuit 531e may be the target path circuits in the third period TP3.

In the third period TP3, the first gating signal VG1 and the fifth gating signal VG5 may have the activation levels and the second to fourth gating signals VG2 to VG4 and the sixth to tenth gating signals VG6 to VG10 may have the deactivation levels.

As the first gating signal VG1 and the fifth gating signal VG5 have the activation levels in the third period TP3, the first path circuit 531a and the fifth path circuit 531e may be activated. In addition, as the second to fourth gating signals VG2 to VG4 and the sixth to tenth gating signals VG6 to VG10 have the deactivation levels in the third period TP3, the second to fourth path circuits 531b to 531d and the sixth to tenth path circuits 531f to 531j may be deactivated.

According to the same method described above with reference to FIG. 7 and FIG. 8, the data signal DATA may be inverted by the input inverter IN0, the first path circuit 531a which is activated, and the fifth path circuit 531e which is activated. The data signal DATA, which is inverted, may be transmitted to the third output block S3. The high voltage may be transmitted to the first output block S1, the second output block S2, and the fourth to eighth output blocks S4 to S8.

The data signal DATA, which is inverted, of the eleventh node N11 may be inverted to the data signal DATA by the third output block S3. In addition, the high voltage of each of the seventh node N7, the ninth node N9, the thirteenth node N13, the fifteenth node N15, the seventeenth node N17, the nineteenth node N19, and the 21-th node N21 may be inverted to the low voltage by the first output block S1, the second output block S2, and the fourth to eighth output blocks S4 to S8.

The data signal DATA may be transmitted to the 129-th to 192-th latch circuits. In addition, the data signal DATA may be stored in one of the 129-th to 192-th latch circuits based on the enable signals EN. In an embodiment, for example, when the 129-th enable signal has the activation level, the 129-th data signal DATA129 may be stored in the 129-th latch circuit. In addition, when the 130-th enable signal has the activation level, the 130-th data signal DATA130 may be stored in the 130-th latch circuit. In this way, when the 192-th enable signal has the activation level, the 192-th data signal DATA192 may be stored in the 192-th latch circuit.

Referring to FIG. 11, the data signal DATA may be applied to the input terminal of the input inverter IN0. The data signal DATA may be one of 193-th to 256-th data signals DATA193 to DATA256.

In the fourth period TP4 of FIG. 5, the fourth data transmission path may be the target transmission path which transmits the data signal DATA to the latch block 540.

The fourth data transmission path may include the input inverter IN0, the first path circuit 531a, and the sixth path circuit 531f. The first path circuit 531a and the sixth path circuit 531f may be the target path circuits in the fourth period TP4.

In the fourth period TP4, the first gating signal VG1 and the sixth gating signal VG6 may have the activation levels and the second to fifth gating signals VG2 to VG5 and the seventh to tenth gating signals VG7 to VG10 may have the deactivation levels.

As the first gating signal VG1 and the sixth gating signal VG6 have the activation levels in the fourth period TP4, the first path circuit 531a and the sixth path circuit 531f may be activated. In addition, as the second to fifth gating signals VG2 to VG5 and the seventh to tenth gating signals VG7 to VG10 have the deactivation levels in the fourth period TP4, the second to fifth path circuits 531b to 531e and the seventh to tenth path circuits 531g to 531j may be deactivated.

According to the same method described above with reference to FIG. 7 and FIG. 8, the data signal DATA may be inverted by the input inverter IN0, the first path circuit 531a which is activated, and the sixth path circuit 531f which is activated. The data signal DATA, which is inverted, may be transmitted to the fourth output block S4. The high voltage may be transmitted to the first to third output blocks S1 to S3, and the fifth to eighth output blocks S5 to S8.

The data signal DATA, which is inverted, of the thirteenth node N13 may be inverted to the data signal DATA by the fourth output block S4. In addition, the high voltage of each of the seventh node N7, the ninth node N9, the eleventh node N11, the fifteenth node N15, the seventeenth node N17, the nineteenth node N19, and the 21-th node N21 may be inverted to the low voltage by the first to third output blocks S1 to S3, and the fifth to eighth output blocks S5 to S8.

The data signal DATA may be transmitted to the 193-th to 256-th latch circuits. In addition, the data signal DATA may be stored in one of the 193-th to 256-th latch circuits based on the enable signals EN. In an embodiment, for example, when the 193-th enable signal has the activation level, the 193-th data signal DATA193 may be stored in the 193-th latch circuit. In addition, when the 194-th enable signal has the activation level, the 194-th data signal DATA194 may be stored in the 194-th latch circuit. In this way, when the 256-th enable signal has the activation level, the 256-th data signal DATA256 may be stored in the 256-th latch circuit.

Referring to FIG. 12, the data signal DATA may be applied to the input terminal of the input inverter IN0. The data signal DATA may be one of 257-th to 320-th data signals DATA257 to DATA320.

In the fifth period TP5 of FIG. 5, the fifth data transmission path may be the target transmission path which transmits the data signal DATA to the latch block 540.

The fifth data transmission path may include the input inverter IN0, the second path circuit 531b, and the seventh path circuit 531g. The second path circuit 531b and the seventh path circuit 531g may be the target path circuits in the fifth period TP5.

In the fifth period TP5, the second gating signal VG2 and the seventh gating signal VG7 may have the activation levels and the first gating signal VG1, the third to sixth gating signals VG3 to VG6, and the eighth to tenth gating signals VG8 to VG10 may have the deactivation levels.

As the second gating signal VG2 and the seventh gating signal VG7 have the activation levels in the fifth period TP5, the second path circuit 531b and the seventh path circuit 531g may be activated. In addition, as the first gating signal VG1, the third to sixth gating signals VG3 to VG6, and the eighth to tenth gating signals VG8 to VG10 have the deactivation levels in the fifth period TP5, the first path circuit 531a, the third to sixth path circuits 531c to 531f, and the eighth to tenth path circuits 531h to 531j may be deactivated.

According to the same method described above with reference to FIG. 7 and FIG. 8, the data signal DATA may be inverted by the input inverter IN0, the second path circuit 531b which is activated, and the seventh path circuit 531g which is activated. The data signal DATA, which is inverted, may be transmitted to the fifth output block S5. The high voltage may be transmitted to the first to fourth output blocks S1 to S4 and the sixth to eighth output blocks S6 to S8.

The data signal DATA, which is inverted, of the fifteenth node N15 may be inverted to the data signal DATA by the fifth output block S5. In addition, the high voltage of each of the seventh node N7, the ninth node N9, the eleventh node N11, the thirteenth node N13, the seventeenth node N17, the nineteenth node N19, and the 21-th node N21 may be inverted to the low voltage by the first to fourth output blocks S1 to S4 and the sixth to eighth output blocks S6 to S8.

The data signal DATA may be transmitted to the 257-th to 320-th latch circuits. In addition, the data signal DATA may be stored in one of the 257-th to 320-th latch circuits based on the enable signals EN. In an embodiment, for example, when the 257-th enable signal has the activation level, the 257-th data signal DATA257 may be stored in the 257-th latch circuit. In addition, when the 258-th enable signal has the activation level, the 258-th data signal DATA258 may be stored in the 258-th latch circuit. In this way, when the 320-th enable signal has the activation level, the 320-th data signal DATA320 may be stored in the 320-th latch circuit.

Referring to FIG. 13, the data signal DATA may be applied to the input terminal of the input inverter IN0. The data signal DATA may be one of 321-th to 384-th data signals DATA321 to DATA384.

In the sixth period TP6 of FIG. 5, the sixth data transmission path may be the target transmission path which transmits the data signal DATA to the latch block 540.

The sixth data transmission path may include the input inverter IN0, the second path circuit 531b, and the eighth path circuit 531h. The second path circuit 531b and the eight path circuit 531h may be the target path circuits in the sixth period TP6.

In the sixth period TP6, the second gating signal VG2 and the eighth gating signal VG8 may have the activation levels and the first gating signal VG1, the third to seventh gating signals VG3 to VG7, the ninth gating signal VG9, and tenth gating signal VG10 may have the deactivation levels.

As the second gating signal VG2 and the eighth gating signal VG8 have the activation levels in the sixth period TP6, the second path circuit 531b and the eighth path circuit 531h may be activated. In addition, as the first gating signal VG1, the third to seventh gating signals VG3 to VG7, the ninth gating signal VG9, and the tenth gating signal VG10 have the deactivation levels in the sixth period TP6, the first path circuit 531a, the third to seventh path circuits 531c to 531g, the ninth path circuits 531i, and the tenth path circuit 531j may be deactivated.

According to the same method described above with reference to FIG. 7 and FIG. 8, the data signal DATA may be inverted by the input inverter IN0, the second path circuit 531b which is activated, and the eighth path circuit 531h which is activated. The data signal DATA, which is inverted, may be transmitted to the sixth output block S6. The high voltage may be transmitted to the first to fifth output blocks S1 to S5, the seventh output block S7, and the eighth output block S8.

The data signal DATA, which is inverted, of the seventeenth node N17 may be inverted to the data signal DATA by the sixth output block S6. In addition, the high voltage of each of the seventh node N7, the ninth node N9, the eleventh node N11, the thirteenth node N13, the fifteenth node N15, the nineteenth node N19, and the 21-th node N21 may be inverted to the low voltage by the first to fifth output blocks S1 to S5, the seventh output block S7, and the eighth output block S8.

The data signal DATA may be transmitted to the 321-th to 384-th latch circuits. In addition, the data signal DATA may be stored in one of the 321-th to 384-th latch circuits based on the enable signals EN. In an embodiment, for example, when the 321-th enable signal has the activation level, the 321-th data signal DATA321 may be stored in the 321-th latch circuit. In addition, when the 322-th enable signal has the activation level, the 322-th data signal DATA322 may be stored in the 322-th latch circuit. In this way, when the 384-th enable signal has the activation level, the 384-th data signal DATA384 may be stored in the 384-th latch circuit.

Referring to FIG. 14, the data signal DATA may be applied to the input terminal of the input inverter IN0. The data signal DATA may be one of 385-th to 448-th data signals DATA385 to DATA448.

In the seventh period TP7 of FIG. 5, the seventh data transmission path may be the target transmission path which transmits the data signal DATA to the latch block 540.

The seventh data transmission path may include the input inverter IN0, the second path circuit 531b, and the ninth path circuit 531i. The second path circuit 531b and the ninth path circuit 531i may be the target path circuits in the seventh period TP7.

In the seventh period TP7, the second gating signal VG2 and the ninth gating signal VG9 may have the activation levels and the first gating signal VG1, the third to eighth gating signals VG3 to VG8, and tenth gating signal VG10 may have the deactivation levels.

As the second gating signal VG2 and the ninth gating signal VG9 have the activation levels in the seventh period TP7, the second path circuit 531b and the ninth path circuit 531i may be activated. In addition, as the first gating signal VG1, the third to eighth gating signals VG3 to VG8, and the tenth gating signal VG10 have the deactivation levels in the seventh period TP7, the first path circuit 531a, the third to eighth path circuits 531c to 531h, and the tenth path circuit 531j may be deactivated.

According to the same method described above with reference to FIG. 7 and FIG. 8, the data signal DATA may be inverted by the input inverter IN0, the second path circuit 531b which is activated, and the ninth path circuit 531i which is activated. The data signal DATA, which is inverted, may be transmitted to the seventh output block S7. The high voltage may be transmitted to the first to sixth output blocks S1 to S6 and the eighth output block S8.

The data signal DATA, which is inverted, of the nineteenth node N19 may be inverted to the data signal DATA by the seventh output block S7. In addition, the high voltage of each of the seventh node N7, the ninth node N9, the eleventh node N11, the thirteenth node N13, the fifteenth node N15, the seventeenth node N17, and the 21-th node N21 may be inverted to the low voltage by the first to sixth output blocks S1 to S6 and the eighth output block S8.

The data signal DATA may be transmitted to the 385-th to 448-th latch circuits. In addition, the data signal DATA may be stored in one of the 385-th to 448-th latch circuits based on the enable signals EN. In an embodiment, for example, when the 385-th enable signal has the activation level, the 385-th data signal DATA385 may be stored in the 385-th latch circuit. In addition, when the 386-th enable signal has the activation level, the 386-th data signal DATA386 may be stored in the 386-th latch circuit. In this way, when the 448-th enable signal has the activation level, the 448-th data signal DATA448 may be stored in the 448-th latch circuit.

Referring to FIG. 15, the data signal DATA may be applied to the input terminal of the input inverter IN0. The data signal DATA may be one of 449-th to 512-th data signals DATA449 to DATA512.

In the eighth period TP8 of FIG. 5, the eighth data transmission path may be the target transmission path which transmits the data signal DATA to the latch block 540.

The eighth data transmission path may include the input inverter IN0, the second path circuit 531b, and the tenth path circuit 531j. The second path circuit 531b and the tenth path circuit 531j may be the target path circuits in the eighth period TP8.

In the eighth period TP8, the second gating signal VG2 and the tenth gating signal VG10 may have the activation levels and the first gating signal VG1 and the third to ninth gating signals VG3 to VG9 may have the deactivation levels.

As the second gating signal VG2 and the tenth gating signal VG10 have the activation levels in the eighth period TP8, the second path circuit 531b and the tenth path circuit 531j may be activated. In addition, as the first gating signal VG1 and the third to ninth gating signals VG3 to VG9 have the deactivation levels in the eighth period TP8, the first path circuit 531a and the third to ninth path circuits 531c to 531i may be deactivated.

According to the same method described above with reference to FIG. 7 and FIG. 8, the data signal DATA may be inverted by the input inverter IN0, the second path circuit 531b which is activated, and the tenth path circuit 531j which is activated. The data signal DATA, which is inverted, may be transmitted to the eighth output block S8. The high voltage may be transmitted to the first to seventh output blocks S1 to S7.

The data signal DATA, which is inverted, of the 21-th node N21 may be inverted to the data signal DATA by the eighth output block S8. In addition, the high voltage of each of the seventh node N7, the ninth node N9, the eleventh node N11, the thirteenth node N13, the fifteenth node N15, the seventeenth node N17, and the nineteenth node N19 may be inverted to the low voltage by the first to seventh output blocks S1 to S7.

The data signal DATA may be transmitted to the 449-th to 512-th latch circuits. In addition, the data signal DATA may be stored in one of the 449-th to 512-th latch circuits based on the enable signals EN. In an embodiment, for example, when the 449-th enable signal has the activation level, the 449-th data signal DATA449 may be stored in the 449-th latch circuit. In addition, when the 450-th enable signal has the activation level, the 450-th data signal DATA450 may be stored in the 450-th latch circuit. In this way, when the 512-th enable signal has the activation level, the 512-th data signal DATA512 may be stored in the 512-th latch circuit.

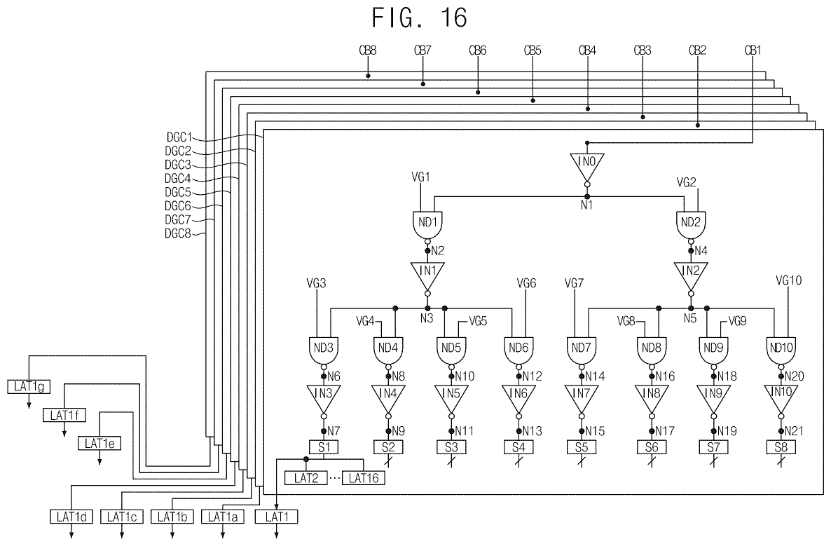

FIG. 16 is a diagram illustrating a process of transmitting the data signal DATA through the data transmission block 530 of FIG. 4.

Referring to FIG. 16, each of the first to eighth data gating circuits DGC1 to DGC8 may receive the first to eighth component bits included in the data signal DATA. Each of the first to eighth data gating circuits DGC1 to DGC8 may transmit each of the first to eighth component bits CB1 to CB8 to the first to eighth latch blocks LATs1 to LATs8 through the target transmission path. For convenience of illustration and description, a case where the data signal DATA is the first data signal DATA1 and the target transmission path is the first data transmission path of each of the first to eighth data gating circuits DGC1 to DGC8 will be mainly described.

The first component bit CB1 of the first data signal DATA1 may be transmitted to the first latch circuit LAT1 of the first latch block LATs1 through the first data transmission path of the first data gating circuit DGC1. The first component bit CB1 may be stored in the first latch circuit LAT1 of the first latch block LATs1 based on the first enable signal EN[1] which has the activation level.

The second component bit CB2 of the first data signal DATA1 may be transmitted to the first latch circuit LATla of the second latch block LATs2 through the first data transmission path of the second data gating circuit DGC2. The second component bit CB2 may be stored in the first latch circuit LATla of the second latch block LATs2 based on the first enable signal EN[1] which has the activation level.

The third component bit CB3 of the first data signal DATA1 may be transmitted to the first latch circuit LAT1b of the third latch block LATs3 through the first data transmission path of the third data gating circuit DGC3. The third component bit CB3 may be stored in the first latch circuit LAT1b of the third latch block LATs3 based on the first enable signal EN[1] which has the activation level.

The fourth component bit CB4 of the first data signal DATA1 may be transmitted to the first latch circuit LAT1c of the fourth latch block LATs4 through the first data transmission path of the fourth data gating circuit DGC4. The fourth component bit CB4 may be stored in the first latch circuit LATIc of the fourth latch block LATs4 based on the first enable signal EN[1] which has the activation level.

The fifth component bit CB5 of the first data signal DATA1 may be transmitted to the first latch circuit LAT1d of the fifth latch block LATs5 through the first data transmission path of the fifth data gating circuit DGC5. The fifth component bit CB5 may be stored in the first latch circuit LAT1d of the fifth latch block LATs5 based on the first enable signal EN[1] which has the activation level.

The sixth component bit CB6 of the first data signal DATA1 may be transmitted to the first latch circuit LAT1e of the sixth latch block LATs6 through the first data transmission path of the sixth data gating circuit DGC6. The sixth component bit CB6 may be stored in the first latch circuit LAT1e of the sixth latch block LATs6 based on the first enable signal EN[1] which has the activation level.

The seventh component bit CB7 of the first data signal DATA1 may be transmitted to the first latch circuit LAT1f of the seventh latch block LATs7 through the first data transmission path of the seventh data gating circuit DGC7. The seventh component bit CB7 may be stored in the first latch circuit LAT1f of the seventh latch block LATs7 based on the first enable signal EN[1] which has the activation level.

The eighth component bit CB8 of the first data signal DATA1 may be transmitted to the first latch circuit LAT1g of the eighth latch block LATs8 through the first data transmission path of the eighth data gating circuit DGC8. The eighth component bit CB8 may be stored in the first latch circuit LAT1g of the eighth latch block LATs8 based on the first enable signal EN[1] which has the activation level.

The first to eighth component bits CB1 to CB8, which are stored in the first to eighth latch blocks LATs1 to LATs8, may be output based on the load signal Load.

In an embodiment, the first to eighth component bits CB1 to CB8 may be output to a multiplexing block (not shown) which selectively transmits the data signal DATA to a digital-to-analog converting (DAC) block (not shown). In an embodiment, for example, the multiplexing block may include multiplexers (MUXs). The multiplexing block may selectively transmit the first to eighth component bits CB1 to CB8 to the DAC block. The DAC block may generate a first data voltage based on the first to eighth component bits CB1 to CB8 transmitted from the multiplexing block and may output the first data voltage to the first data line DL[1].

In an embodiment, the first to eighth component bits CB1 to CB8 may be transmitted to the DAC block. The DAC block may generate the first data voltage based on the first to eighth component bits CB1 to CB8 and may output the first data voltage to the first data line DL[1].

In an embodiment, a value of the first data signal DATA1 may be “00101101”. A value of the first component bit CB1 may be “0”. A value of the second component bit CB2 may be “0”. A value of the third component bit CB3 may be “1”. A value of the fourth component bit CB4 may be “0”. A value of the fifth component bit CB5 may be “1”. A value of the sixth component bit CB6 may be “1”. A value of the seventh component bit CB7 may be “0”. A value of the eighth component bit CB8 may be “1”.

The first to eighth component bits CB1 to CB8 may be transmitted to the first to eighth latch blocks LATs1 to LATs8 through the first data transmission path of each of the first to eighth data gating circuits DGC1 to DGC8. In addition, the value of the first component bit CB1, which is “0”, may be stored in the first latch circuit LAT1 of the first latch block LATs1 based on the first enable signal EN[1]. The value of the second component bit CB2, which is “0”, may be stored in the first latch circuit LAT1a of the second latch block LATs2 based on the first enable signal EN[1]. The value of the third component bit CB3, which is “1”, may be stored in the first latch circuit LAT1b of the third latch block LATs3 based on the first enable signal EN[1]. The value of the fourth component bit CB4, which is “0”, may be stored in the first latch circuit LAT1c of the fourth latch block LATs4 based on the first enable signal EN[1]. The value of the fifth component bit CB5, which is “1”, may be stored in the first latch circuit LAT1d of the fifth latch block LATs5 based on the first enable signal EN[1]. The value of the sixth component bit CB6, which is “1”, may be stored in the first latch circuit LAT1e of the sixth latch block LATs6 based on the first enable signal EN[1]. The value of the seventh component bit CB7, which is “0”, may be stored in the first latch circuit LAT If of the seventh latch block LATs7 based on the first enable signal EN[1]. In addition, the value of the eighth component bit CB8, which is “1”, may be stored in the first latch circuit LAT1g of the eighth latch block LATs8 based on the first enable signal EN[1].

The value of the first to eighth component bits CB1 to CB8, “00101101”, stored in the first to eighth latch blocks LATs1 to LATs8, may be output to the DAC block based on the load signal Load. The DAC block may generate the first data voltage corresponding to the value of the first to eighth component bits CB1 to CB8 which are “00101101”. The DAC block may output the first data voltage to the first data line DL[1].

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In addition, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

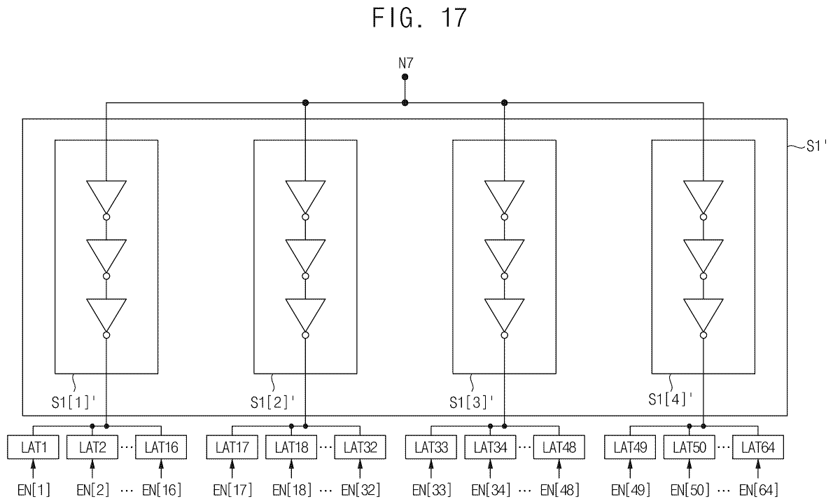

FIG. 17 is a diagram illustrating an embodiment of an output block included in the data gating circuit DGC of FIG. 6.

Referring to FIG. 17, in an embodiment, a first output block S1′ may include first to fourth output circuits S1[1]′ to S1[4]′. The first output blocks S1′ of FIG. 17 is substantially the same as the first output block S1 of FIG. 8 except for the number of the inverters included in the first to the fourth output circuits S1[1]′ to S1[4]′. Thus, the same reference numerals will be used to refer to the same or like elements as those of the embodiment described above with reference to FIG. 8 and any repetitive detailed description thereof will be omitted.

Each of the first to fourth output circuits S1[1]′ to S1[4]′ may include N inverters which are connected to each other in series, where Nis an odd integer greater than or equal to 3. Each of the first to fourth output circuits S1[1]′ to S1[4]′ may invert the data signal DATA, which is inverted, of the seventh node N7. That is, each of the first to fourth output circuits S1[1]′ to S1[4]′ may output the data signal DATA.

In an embodiment, each of the first to fourth output circuits S1[1]′ to S1[4]′ may include 3 inverters which are connected to each other in series.

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

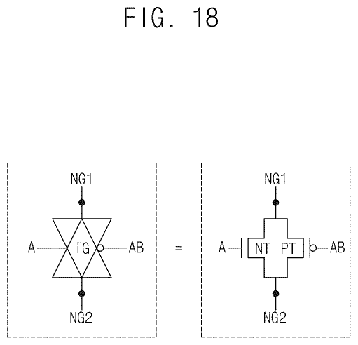

FIG. 18 is a diagram illustrating a transmission gate TG.

Referring to FIG. 18, in an embodiment, the transmission gate TG may include a first control electrode which receives a first signal A, a second control electrode which receives a second signal AB which has opposite phase to the first signal A, a first electrode connected to a first gate node NG1, and a second electrode connected to a second gate node NG2.

The transmission gate TG may include one N-channel metal oxide semiconductor (NMOS) transistor NT and one P-channel metal oxide semiconductor (PMOS) transistor PT. The NMOS transistor NT may include a control electrode which receives the first signal A, a first electrode connected to the first gate node NG1, and a second electrode connected to the second gate node NG2. The PMOS transistor PT may include a control electrode which receives the second signal AB which has opposite phase to the first signal A, a first electrode connected to the first gate node NG1, and a second electrode connected to the second gate node NG2. The first electrode of the NMOS transistor NT and the first electrode of the PMOS transistor PT may be connected through the first gate node NG1. The second electrode of the NMOS transistor NT and the second electrode of the PMOS transistor PT may be connected through the second gate node NG2. The control electrode of the NMOS transistor NT may correspond to the first control electrode of the transmission gate TG. The control electrode of the PMOS transistor PT may correspond to the second control electrode of the transmission gate TG. The first electrode of the NMOS transistor NT and the first electrode of the PMOS transistor PT may correspond to the first electrode of the transmission gate TG. The second electrode of the NMOS transistor NT and the second electrode of the PMOS transistor PT may correspond to the second electrode of the transmission gate TG.

When the first signal A has the high level and the second signal AB has the low level, the NMOS transistor NT and the PMOS transistor PT may be turned on. Accordingly, the transmission gate TG may be turned on. When the transmission gate TG is turned on, the transmission gate TG may transmit a voltage of the first gate node NG1 to the second gate node NG2.

When the transmission gate TG is turned on, a voltage drop may be decreased compared to a case where only one of the NMOS transistor NT and the PMOS transistor PT is turned on. Accordingly, the transmission gate TG may stably transmit the voltage of the first gate node NG1 to the second gate node NG2.

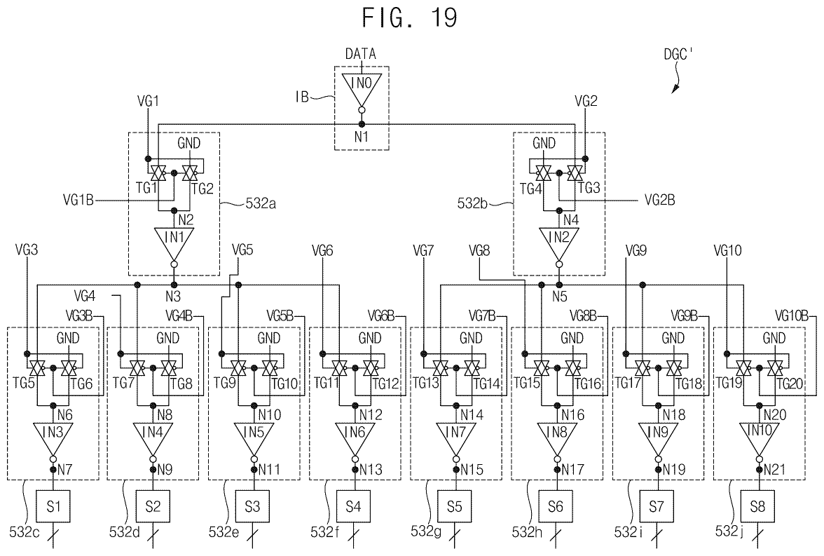

FIG. 19 is a circuit diagram illustrating an embodiment of a data gating circuit DGC′ included in the data transmission block 530 of FIG. 4.

Referring to FIG. 19, an embodiment of the data gating circuit DGC′ may include the input block IB, first to tenth path circuits 532a to 532j, and the first to eighth output blocks S1 to S8. The data gating circuit DGC′ is substantially the same as the data gating circuit DGC of FIG. 6 except that the first to tenth path circuits 532a to 532j includes first to twentieth transmission gates TG1 to TG20 instead of the first to tenth NAND gates ND1 to ND10 and further receives first to tenth gating inversion signals VGIB to VG10B. Thus, the same reference numerals will be used to refer to the same or like elements as those of the embodiment described above with reference to FIG. 6 and any repetitive detailed description thereof will be omitted.

In an embodiment, the gating signal generating block 520 may further generate the first to tenth gating inversion signals VG1B to VG10B which have opposite phases to the first to tenth gating signals VG1 to VG10 and may output the first to tenth gating inversion signals VG1B to VG10B to the data driver 500.

Each of the first to tenth path circuits 532a to 532j may include two switching elements and one inverter. The switching element may be the transmission gate TG.

The first path circuit 532a may include a first transmission gate TG1, a second transmission gate TG2, and the first inverter IN1.

The first transmission gate TG1 may include a first control electrode which receives the first gating signal VG1, a second control electrode which receives the first gating inversion signal VG1B which has opposite phase to the first gating signal VG1, a first electrode connected to the first node N1, and a second electrode connected to the second node N2.

The second transmission gate TG2 may include a first control electrode which receives the first gating inversion signal VG1B, a second control electrode which receives the first gating signal VG1, a first electrode which receives a ground voltage GND, and a second electrode connected to the second node N2.

The second path circuit 532b may include a third transmission gate TG3, a fourth transmission gate TG4, and the second inverter IN2.

The third transmission gate TG3 may include a first control electrode which receives the second gating signal VG2, a second control electrode which receives the second gating inversion signal VG2B which has opposite phase to the second gating signal VG2, a first electrode connected to the first node N1, and a second electrode connected to the fourth node N4.

The fourth transmission gate TG4 may include a first control electrode which receives the second gating inversion signal VG2B, a second control electrode which receives the second gating signal VG2, a first electrode which receives the ground voltage GND, and a second electrode connected to the fourth node N4.

The third path circuit 532c may include a fifth transmission gate TG5, a sixth transmission gate TG6, and the third inverter IN3.

The fifth transmission gate TG5 may include a first control electrode which receives the third gating signal VG3, a second control electrode which receives the third gating inversion signal VG3B which has opposite phase to the third gating signal VG3, a first electrode connected to the third node N3, and a second electrode connected to the sixth node N6.

The sixth transmission gate TG6 may include a first control electrode which receives the third gating inversion signal VG3B, a second control electrode which receives the third gating signal VG3, a first electrode which receives the ground voltage GND, and a second electrode connected to the sixth node N6.

The fourth path circuit 532d may include a seventh transmission gate TG7, an eighth transmission gate TG8, and the fourth inverter IN4.

The seventh transmission gate TG7 may include a first control electrode which receives the fourth gating signal VG4, a second control electrode which receives the fourth gating inversion signal VG4B which has opposite phase to the fourth gating signal VG4, a first electrode connected to the third node N3, and a second electrode connected to the eighth node N8.

The eighth transmission gate TG8 may include a first control electrode which receives the fourth gating inversion signal VG4B, a second control electrode which receives the fourth gating signal VG4, a first electrode which receives the ground voltage GND, and a second electrode connected to the eighth node N8.

The fifth path circuit 532e may include a ninth transmission gate TG9, a tenth transmission gate TG10, and the fifth inverter IN5.

The ninth transmission gate TG9 may include a first control electrode which receives the fifth gating signal VG5, a second control electrode which receives the fifth gating inversion signal VG5B which has opposite phase to the fifth gating signal VG5, a first electrode connected to the third node N3, and a second electrode connected to the tenth node N10.

The tenth transmission gate TG10 may include a first control electrode which receives the fifth gating inversion signal VG5B, a second control electrode which receives the fifth gating signal VG5, a first electrode which receives the ground voltage GND, and a second electrode connected to the tenth node N10.

The sixth path circuit 532f may include an eleventh transmission gate TG11, a twelfth transmission gate TG12, and the sixth inverter IN6.

The eleventh transmission gate TG11 may include a first control electrode which receives the sixth gating signal VG6, a second control electrode which receives the sixth gating inversion signal VG6B which has opposite phase to the sixth gating signal VG6, a first electrode connected to the third node N3, and a second electrode connected to the twelfth node N12.

The twelfth transmission gate TG12 may include a first control electrode which receives the sixth gating inversion signal VG6B, a second control electrode which receives the sixth gating signal VG6, a first electrode which receives the ground voltage GND, and a second electrode connected to the twelfth node N12.

The seventh path circuit 532g may include a thirteenth transmission gate TG13, a fourteenth transmission gate TG14, and the seventh inverter IN7.

The thirteenth transmission gate TG13 may include a first control electrode which receives the seventh gating signal VG7, a second control electrode which receives the seventh gating inversion signal VG7B which has opposite phase to the seventh gating signal VG7, a first electrode connected to the third node N3, and a second electrode connected to the fourteenth node N14.

The fourteenth transmission gate TG14 may include a first control electrode which receives the seventh gating inversion signal VG7B, a second control electrode which receives the seventh gating signal VG7, a first electrode which receives the ground voltage GND, and a second electrode connected to the fourteenth node N14.

The eighth path circuit 532h may include a fifteenth transmission gate TG15, a sixteenth transmission gate TG16, and the eighth inverter IN8.

The fifteenth transmission gate TG15 may include a first control electrode which receives the eighth gating signal VG8, a second control electrode which receives the eighth gating inversion signal VG8B which has opposite phase to the eighth gating signal VG8, a first electrode connected to the fifth node N5, and a second electrode connected to the sixteenth node N16.

The sixteenth transmission gate TG16 may include a first control electrode which receives the eighth gating inversion signal VG8B, a second control electrode which receives the eighth gating signal VG8, a first electrode which receives the ground voltage GND, and a second electrode connected to the sixteenth node N16.

The ninth path circuit 532i may include a seventeenth transmission gate TG17, an eighteenth transmission gate TG18, and the ninth inverter IN9.

The seventeenth transmission gate TG17 may include a first control electrode which receives the ninth gating signal VG9, a second control electrode which receives the ninth gating inversion signal VG9B which has opposite phase to the ninth gating signal VG9, a first electrode connected to the fifth node N5, and a second electrode connected to the eighteenth node N18.

The eighteenth transmission gate TG18 may include a first control electrode which receives the ninth gating inversion signal VG9B, a second control electrode which receives the ninth gating signal VG9, a first electrode which receives the ground voltage GND, and a second electrode connected to the eighteenth node N18.

The tenth path circuit 532j may include a nineteenth transmission gate TG19, a twentieth transmission gate TG20, and the tenth inverter IN10.

The nineteenth transmission gate TG19 may include a first control electrode which receives the tenth gating signal VG10, a second control electrode which receives the tenth gating inversion signal VG10B which has opposite phase to the tenth gating signal VG10, a first electrode connected to the fifth node N5, and a second electrode connected to the twentieth node N20.

The twentieth transmission gate TG20 may include a first control electrode which receives the tenth gating inversion signal VG10B, a second control electrode which receives the tenth gating signal VG10, a first electrode which receives the ground voltage GND, and a second electrode connected to the twentieth node N20.

In an embodiment, in the first period TP1 of FIG. 5, the first gating signal VG1 and the third gating signal VG3 may have the high levels and the second gating signal VG2 and the fourth to tenth gating signals VG4 to VG10 may have the low levels. In the first period TP1, the first gating inversion signal VG1B and the third gating inversion signal VG3B may have the low levels and the second gating inversion signal VG2B and the fourth to tenth gating inversion signals VG4B to VG10B may have the high levels. The data signal DATA, which is inverted, may transmitted to the first output block S1 through the first data transmission path.

The data signal DATA may be applied to the input terminal of the input inverter IN0. In addition, the input inverter IN0 may output the data signal DATA, which is inverted, to the first node N1.

When the first gating signal VG1 has the high level and the first gating inversion signal VG1B has the low level, the first transmission gate TG1 may be turned on and the second transmission gate TG2 may be turned off. Accordingly, the first transmission gate TG1 may transmit the data signal DATA, which is inverted, of first node N1 to the second node N2. In addition, the first inverter IN1 may invert the data signal DATA, which is inverted, of the second node N2. Accordingly, the first inverter IN1 may output the data signal DATA to the third node N3.

When the third gating signal VG3 has the high level and the third gating inversion signal VG3B has the low level, the fifth transmission gate TG5 may be turned on and the sixth transmission gate TG6 may be turned off. Accordingly, the fifth transmission gate TG5 may transmit the data signal DATA of the third node N3 to the sixth node N6. In addition, the third inverter IN3 may invert the data signal DATA of the sixth node N6. Accordingly, the third inverter IN3 may output the data signal DATA, which is inverted, to the seventh node N7.

The first output block S1 may receive the data signal DATA which is inverted and may invert the data signal DATA which is inverted. Accordingly, the first output block S1 may transmit the data signal DATA to the first latch block LATs1.

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

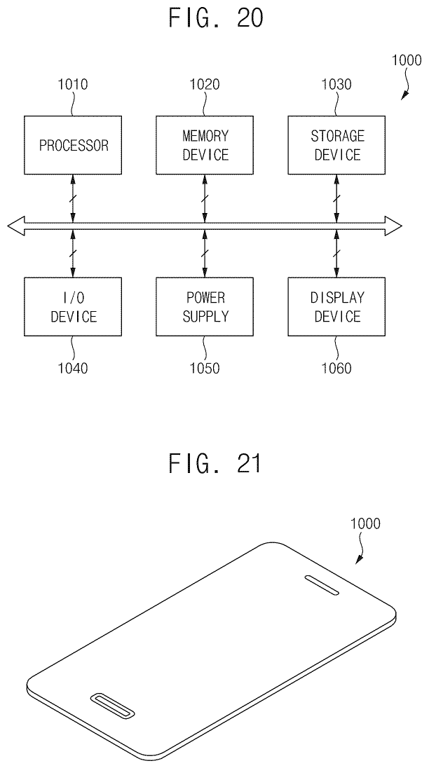

FIG. 20 is a block diagram illustrating an electronic device 1000 according to embodiments. FIG. 21 is a diagram illustrating an example in which the electronic device 1000 of FIG. 20 is implemented as a smart phone.

Referring to FIGS. 20 and 21, an embodiment of the electronic device 1000 may include a processor 1010, a memory device 1020, a storage device 1030, an input/output (I/O) device 1040, a power supply 1050 and a display device 1060. In addition, the electronic device 1000 may further include ports for communicating with a video card, a sound card, a memory card, a universal serial bus (USB) device, other electronic device, or the like.

In an embodiment, as illustrated in FIG. 21, the electronic device 1000 may be implemented as the smart phone. However, the electronic device 1000 is not limited thereto. In an embodiment, for example, the electronic device 1000 may be implemented as a cellular phone, a video phone, a smart pad, a smart watch, a tablet personal computer (PC), a car navigation system, a computer monitor, a laptop, a head mounted display (HMD) device, or the like.

The processor 1010 may perform various computing functions. The processor 1010 may be a micro processor, a central processing unit (CPU), an application processor (AP), or the like. The processor 1010 may be coupled to other components via an address bus, a control bus, a data bus, or the like. Further, the processor 1010 may be coupled to an extended bus such as a peripheral component interconnection (PCI) bus.

In an embodiment, the display device 1060 may be the display device 1 of FIG. 1. The processor 1010 may output the input image data IMG and the input control signal CONT to the driving controller 200 included in the display device 1 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like, and an output device such as a printer, a speaker, and the like. According to an embodiment, the I/O device 1040 may include the display device 1060. The power supply 1050 may provide power for operations of the electronic device 1000. The display device 1060 may be connected to other components through buses or other communication links.

In such an embodiment, the display device 1060 may be the display device 1 of FIG. 1. The display device 1 may include the data driver 500 which receives the data signal DATA from the driving controller 200 and generates the data voltage. The data driver 500 may include the shift register 510 which generates the enable signals EN, the gating signal generating block 520 which generates the gating signal group VGG, the data transmission block 530 which determines the target transmission path through which the data signal DATA is transmitted based on the gating signal group VGG, and the latch block 540 which stores the data signal DATA.

In such an embodiment, the gating signal generating block 520 may generate the gating signal group VGG by using the enable signals EN output from the shift register block 510. Accordingly, the data driver 500 may not use the additional signals transmitted to the gating signal generating block 520 for generating the gating signal group VGG. That is, the data driver 500 may not include the additional driver and the lines for generating the additional signals. Accordingly, the dead space of the display device 1 may be decreased. In such an embodiment, there may be no the power consumption to drive the additional driver which generates the additional signals. That is, the power consumption of the display device 1 may be reduced.

In such an embodiment, the data transmission block 530 may determine the target transmission path through which the data signal DATA is transmitted among the data transmission paths based on the gating signal group VGG which is received from the gating signal generating block 520. The data transmission block 530 may transmit the data signal DATA to the latch block 540 through the target transmission path. As the data signal DATA is not transmitted to the latch block 540 in the time-series manner and the data signal DATA is transmitted to the latch block 540 through the target transmission path, the delays which may be caused by the time-series transmission process may be effectively prevented. Accordingly, the reliability and the stability of the data driver 500 may be improved.

In such an embodiment, as the remaining path circuits included in the data transmission paths except for the target transmission path are deactivated, the data signal DATA may not be transmitted through the data transmission paths except for the target transmission path. Accordingly, the power consumption caused by transmitting the data signal DATA to the latch block 540 may be reduced. That is, the power consumption of the display device 1 may be reduced.

Embodiments of the present disclosures may be applied to a display device and an electronic device including the display device, for example, a television (TV), a digital TV, a three-dimensional (3D) TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A data driver comprising:
a shift register block which generates enable signals based on a data clock signal;
a gating signal generating block which generates gating signals;
a data transmission block including data gating circuits, each of which receives a data signal and transmits the data signal to a latch block; and
the latch block which stores the data signal based on the enable signals,
wherein each of the data gating circuits includes data transmission paths and determines a target transmission path, which transmits the data signal to the latch block, among the data transmission paths based on the gating signals.

2. The data driver of claim 1, wherein the gating signal generating block generates the gating signals based on the enable signals.

3. The data driver of claim 1, wherein each of the data gating circuits includes:
an input block which receives the data signal;
path circuits which transmits the data signal to output blocks based on the gating signals; and
the output blocks which outputs the data signal to the latch block, and
wherein each of the data transmission paths includes the input block, at least one of the path circuits, and at least one of the output blocks.

4. The data driver of claim 3, wherein the input block includes at least one logic gate,
wherein each of the path circuits includes at least one logic gate, and
wherein each of the output blocks includes at least one logic gate.

5. The data driver of claim 3, wherein the input block includes at least one logic gate,
wherein each of the path circuits includes at least one logic gate and at least one switching element, and
wherein each of the output blocks includes at least one logic gate.

6. The data driver of claim 3, wherein
target path circuits, which are included in the target transmission path, among the path circuits are activated based on the gating signals, and
remaining path circuits among the path circuits except for the target path circuits are deactivated based on the gating signals.

7. The data driver of claim 3, wherein the gating signal generating block further generates gating inversion signals, which have opposite phases to the gating signals, based on the enable signals and outputs the gating inversion signals to the data transmission block.

8. The data driver of claim 7, wherein
target path circuits, which are included in the target transmission path, among the path circuits are activated based on the gating signals and the gating inversion signals, and
remaining path circuits among the path circuits except for the target path circuits are deactivated based on the gating signals and the gating inversion signals.

9. The data driver of claim 3, wherein the latch block includes latch circuits,
wherein each of the output blocks includes output circuits, and
wherein each of the output circuits is connected to at least one of the latch circuits.

10. The data driver of claim 1, wherein the gating signal generating block generates first to tenth gating signals,
wherein each of the data gating circuits includes an input block, first to tenth path circuits, and first to eighth output blocks,
wherein the input block includes an input terminal which receives the data signal and an output terminal connected to a first node,
wherein the first path circuit includes a first input terminal which receives the first gating signal, a second input terminal connected to the first node, and an output terminal connected to a third node,
wherein the second path circuit includes a first input terminal which receives the second gating signal, a second input terminal connected to the first node, and an output terminal connected to a fifth node,
wherein the third path circuit includes a first input terminal which receives the third gating signal, a second input terminal connected to the third node, and an output terminal connected to the first output block,
wherein the fourth path circuit includes a first input terminal which receives the fourth gating signal, a second input terminal connected to the third node, and an output terminal connected to the second output block,
wherein the fifth path circuit includes a first input terminal which receives the fifth gating signal, a second input terminal connected to the third node, and an output terminal connected to the third output block,
wherein the sixth path circuit includes a first input terminal which receives the sixth gating signal, a second input terminal connected to the third node, and an output terminal connected to the fourth output block,
wherein the seventh path circuit includes a first input terminal which receives the seventh gating signal, a second input terminal connected to the fifth node, and an output terminal connected to the fifth output block,
wherein the eighth path circuit includes a first input terminal which receives the eighth gating signal, a second input terminal connected to the fifth node, and an output terminal connected to the sixth output block,
wherein the ninth path circuit includes a first input terminal which receives the ninth gating signal, a second input terminal connected to the fifth node, and an output terminal connected to the seventh output block, and
wherein the tenth path circuit includes a first input terminal which receives the tenth gating signal, a second input terminal connected to the fifth node, and an output terminal connected to the eighth output block.

11. A display device comprising:
a display panel including pixels;
a gate driver which transmits a gate signal to the pixels;
a data driver which generates a data voltage based on a data signal and transmits the data voltage to the pixels; and
a driving controller which transmits the data signal to the data driver and controls the data driver and the gate driver,
wherein the data driver includes:
a shift register block which generates enable signals based on a data clock signal;
a gating signal generating block which generates gating signals;
a data transmission block including data gating circuits which receives the data signal and transmits the data signal to a latch block; and
the latch block which stores the data signal based on the enable signals, and
wherein each of the data gating circuits includes data transmission paths and determines a target transmission path, which transmits the data signal to the latch block, among the data transmission paths based on the gating signals.

12. The display device of claim 11, wherein the gating signal generating block generates the gating signals based on the enable signals.

13. The display device of claim 11, wherein each of the data gating circuits includes:
an input block which receives the data signal;
path circuits which transmits the data signal to output blocks based on the gating signals; and
the output blocks which outputs the data signal to the latch block, and
wherein each of the data transmission paths includes the input block, at least one of the path circuits, and at least one of the output blocks.

14. The display device of claim 13, wherein the input block includes at least one logic gate,
wherein each of the path circuits includes at least one logic gate, and
wherein each of the output blocks includes at least one logic gate.

15. The display device of claim 13, wherein the input block includes at least one logic gate,
wherein each of the path circuits includes at least one logic gate and at least one switching element, and
wherein each of the output blocks includes at least one logic gate.

16. The display device of claim 13, wherein
target path circuits, which are included in the target transmission path, among the path circuits are activated based on the gating signals, and
remaining path circuits among the path circuits except for the target path circuits are deactivated based on the gating signals.

17. The display device of claim 13, wherein the gating signal generating block further generates gating inversion signals, which have opposite phases to the gating signals, based on the enable signals and outputs the gating inversion signals to the data transmission block.

18. The display device of claim 17, wherein
target path circuits, which are included in the target transmission path, among the path circuits are activated based on the gating signals and the gating inversion signals, and
remaining path circuits among the path circuits except for the target path circuits are deactivated based on the gating signals and the gating inversion signals.

19. The display device of claim 13, wherein the latch block includes latch circuits,
wherein each of the output blocks includes output circuits, and
wherein each of the output circuits is connected to at least one of the latch circuits.

20. An electronic device comprising:
a processor which generates an input control signal and input image data;
a display panel including pixels;
a gate driver which transmits a gate signal to the pixels;
a data driver which generates a data voltage based on a data signal and transmits the data voltage to the pixels; and
a driving controller which transmits the data signal to the data driver and controls the data driver and the gate driver based on the input control signal and the input image data,
wherein the data driver includes:
a shift register block which generates enable signals based on a data clock signal;
a gating signal generating block which generates gating signals;
a data transmission block including data gating circuits which receives the data signal and transmits the data signal to a latch block; and
the latch block which stores the data signal based on the enable signals, and
wherein each of the data gating circuits includes data transmission paths and determines a target transmission path, which transmits the data signal to the latch block, among the data transmission paths based on the gating signals.
